(19) United States
(12) Patent Application Publication
(10) Pub. No.: US 2024/0025575 A1
(43) Pub. Date: Jan. 25, 2024

(54) ULTRA-LOW FREQUENCY WIRELESS POWER TRANSFER TECHNOLOGY FOR UNMANNED AERIAL VEHICLES

(71) Applicant: FlyX Technologies Inc., Bellevue, WA (US)

(72) Inventors: Kamyar Keikhosravy, Bellevue, WA (US); Farzad Rahbar Ris Foroushan, Bellevue, WA (US)

(21) Appl. No.: 18/355,381

(22) Filed: Jul. 19, 2023

Related U.S. Application Data
(60) Provisional application No. 63/390,717, filed on Jul. 20, 2022.

(51) Int. Cl. B64U 50/35; H02J 50/10; H02J 50/70; H02J 50/40

(52) U.S. Cl. CPC B64U 50/35; H02J 50/10; H02J 50/70; H02J 50/40; B60L 2200/10

(57) ABSTRACT

Systems and methods for charging unmanned aerial vehicles (UAVs) using ultra-low frequency wireless power transfer technology are disclosed herein. In some embodiments, a UAV can carry a wireless power transfer (WPT) unit configured to transfer power from a utility powerline to the UAV. The WPT unit can include a first field guiding portion configured to wirelessly couple to the powerline, a second field guiding portion operatively coupled to the first field guiding portion, and an induction coil operatively coupled to the UAV and at least partially wound around at least one of the first field guiding portion or the second field guiding portion. The first and second field guiding portions can be configured to guide a magnetic field generated by current passing through the powerline toward the induction coil for inductive charging. In some embodiments, the WPT unit can include a capacitor plate and a dielectric material for capacitive charging.

### CROSS-REFERENCE TO RELATED APPLICATIONS

The present application claims the benefit of U.S. Provisional Patent Application No. 63/390,717, filed Jul. 20, 2022, the disclosure of which is incorporated herein by reference in its entirety.

### TECHNICAL FIELD

The present technology generally relates to ultra-low frequency wireless power transfer technology for unmanned aerial vehicles (UAVs), and associated devices, systems, and methods.

### BACKGROUND

There is a current and growing need to inspect and monitor the power grid operational status in real-time and act quickly where necessary to avoid disruption to the supply of electricity to customers. For example, most of the US electrical infrastructure was built in the 1960s and is getting old due to wear and tear effects with ever-increasing pressure from both supply and demand sides. In addition, the large scale of grid infrastructures (e.g., the United States transmission and distribution (T&D) assets include approximately 200,000 miles of transmission lines and 5.5 million miles of distribution lines) and the continuous expansion of grid infrastructure due to the increase in energy demands add more stress to this aging critical system. This presents a significant challenge to T&D asset owners and operators to ensure the operational integrity of a grid electrical infrastructure given its sheer size, geographical location, environmental situation, etc.

### BRIEF DESCRIPTION OF THE DRAWINGS

Features, aspects, and advantages of the presently disclosed technology may be better understood with regard to the following drawings.

FIG. 1 is a diagram illustrating the electrical grid infrastructure in the United States.

FIG. 2 is a diagram illustrating Industry 4.0 technology components.

FIG. 3 is a diagram illustrating example technologies used in managing grid infrastructure in accordance with embodiments of the present technology.

FIG. 4 is a schematic of an unmanned aerial vehicle system in accordance with embodiments of the present technology.

FIGS. 5A-B are perspective and front views, respectively, of a wireless power transfer unit with a horseshoe design in accordance with embodiments of the present technology.

FIG. 6A is a perspective view of a wireless power transfer unit with a clamp design in an open position in accordance with embodiments of the present technology.

FIGS. 6B and 6C are front views of the wireless power transfer unit of FIG. 6A in the open position and in a closed position, respectively.

FIG. 6D is an enlarged sectional view of an airgap control assembly in accordance with embodiments of the present technology.

FIGS. 7A and 7B are perspective and front views, respectively, of a wireless power transfer unit having a hollow portion in accordance with embodiments of the present technology.

FIGS. 8A and 8B are perspective and front views, respectively, of a wireless power transfer unit having a sliding rotational design in accordance with embodiments of the present technology.

FIGS. 9A-C are perspective, front, and side views, respectively, of a wireless power transfer unit with a clamp lock design in accordance with embodiments of the present technology.

FIGS. 10A and 10B are front and perspective views, respectively, of a wireless power transfer unit with a non-straight rail design in accordance with embodiments of the present technology.

FIGS. 11A and 11B are front and perspective views, respectively, of a wireless power transfer unit with a straight rail design in accordance with embodiments of the present technology.

FIGS. 12A-C are perspective, top, and side views, respectively, of two wireless power transfer units with a double lock design in accordance with embodiments of the present technology.

FIGS. 13A and 13B are side and perspective views, respectively, of a wireless power transfer unit with a triple lock design in accordance with embodiments of the present technology.

FIGS. 14A-C are perspective, front, and top views, respectively, of a wireless power transfer unit with a ski design in accordance with embodiments of the present technology.

FIGS. 15A-C are perspective, front, and top views, respectively, of a wireless power transfer unit with a roller design in accordance with embodiments of the present technology.

FIGS. 15D and 15E are front and perspective views, respectively, of a wireless power transfer unit with a levitating plate design in accordance with embodiments of the present technology.

FIG. 16A is a perspective view of a wireless power transfer unit with a capacitor plate and a dielectric material in accordance with embodiments of the present technology.

FIGS. 16B and 16C are front views of the wireless power transfer unit of FIG. 16A contacting a powerline and separated from the powerline, respectively.

FIG. 17 is a schematic of a power transfer system in accordance with embodiments of the present technology.

FIG. 18 is a schematic of a resonant circuit in accordance with embodiments of the present technology.

FIG. 19 is a side view of an unmanned aerial vehicle with a helicopter design in accordance with embodiments of the present technology.

FIG. 20 is a side view of an unmanned aerial vehicle with coaxial rotors in accordance with embodiments of the present technology.

FIG. 21 is a perspective view of an unmanned aerial vehicle system positioned on a powerline in accordance with embodiments of the present technology.

FIG. 22 is a schematic illustrating components for transferring power from a powerline to an unmanned aerial vehicle in accordance with embodiments of the present technology.

FIG. 23 is a schematic illustrating subsystems of an unmanned aerial vehicle in accordance with embodiments of the present technology.

FIG. 24 is a flowchart illustrating a method of transferring power from a powerline to an unmanned aerial vehicle in accordance with embodiments of the present technology.

FIG. 25 is a flowchart illustrating a method of landing an unmanned aerial vehicle on a powerline in accordance with embodiments of the present technology.

FIG. 26 is a flowchart illustrating a method of transferring power from a powerline to an in-flight unmanned aerial vehicle in accordance with embodiments of the present technology.

FIG. 27 is a flowchart illustrating a method of transferring power from a powerline to a locked unmanned aerial vehicle in accordance with embodiments of the present technology.

FIG. 28A is a schematic perspective view of a capacitor plate disposed proximate to powerlines in accordance with embodiments of the present technology.

FIG. 28B is a perspective view of a wireless power transfer unit with inductive and capacitive charging components disposed proximate to powerlines in accordance with embodiments of the present technology.

FIG. 28C is an enlarged perspective view of the wireless power transfer unit of FIG. 28B.

A person skilled in the relevant art will understand that the features shown in the drawings are for purposes of illustrations, and variations, including different and/or additional features and arrangements thereof, are included within the scope of the present technology.

### DETAILED DESCRIPTION

The present technology is directed to devices, systems, and methods for ultra-low frequency wireless power transfer technology for unmanned aerial vehicles (UAVs; also known as drones). In some embodiments, the UAVs can receive power from an electrical grid to extend their flight time through, for example, capacitive and/or inductive coupling to a powerline of the electrical grid. In some embodiments, the UAVs can be configured to monitor, diagnose, predict, inhibit, and/or prevent potential faults in the electrical grid. At a high level, the present technology can provide several benefits to the electric utility industry, which can translate into millions of dollars of cost savings through efficiency gains and lives saved by replacing humans with robots in dangerous situations.

Embodiments of the present technology provides novel approaches to detecting and predicting faults that can lead to failures in transmission and distribution (T&D) assets. In some embodiments, the systems configured in accordance with present technology can monitor and inspect T&D assets using beyond visual line of sight (BVLOS) aerial inspection and monitoring with UAVs to identify anomalies, identify potential risks to the grid operation, facilitate the digital transformation, and/or provide for grid modernization. By obtaining power from the assets that the UAV is inspecting, UAVs in accordance with the present technology can effectively have no range limitations when servicing the T&D assets.

Some embodiments of the present technology include ultra-low frequency (e.g., 50 Hz-60 Hz) wireless power transfer (WPT) units using powerlines as sources of energy to power UAVs. In some embodiments, the WPT units can power UAVs with a weight of less than 1 kg (i.e., 2.2 lbs), less than 250 g (i.e., 0.55 lbs), etc. Such UAVs can be equipped with advanced sensors, edge computing hardware, computer vision (CV), artificial intelligence (AI), and/or machine learning (ML) technologies for navigation and/or to collect information. For example, a representative UAV in accordance with the present technology can include (i) a thermal camera to produce heat maps of transformers to identify energy loss spots, (ii) an optical camera to spot insulator cracks, vegetation encroachment, bird nests, etc. that pose risks to the grid integrity, and/or (iii) other sensor(s) and/or information collection components configured for fault detection and prediction use-cases.

In some embodiments, the WPT units are configured to harvest energy from electromagnetic fields generated by powerlines and charge the UAV batteries when needed, therefore facilitating extended and/or unlimited flight range. UAVs configured in accordance with embodiments of the present technology are expected to remain airborne for significant periods of time (e.g., 24 hours per day and 7 days a week (24/7) or approximately 24/7), fly beyond visual line of sight (BVLOS), complete various missions based on mission requirements, and/or transmit data to cloud computers for further analysis and decision-making processes. That is, the present technology utilizes the electromagnetic energy of a grid infrastructure (e.g., United States grid infrastructure) present anywhere there are T&D assets, to power small unmanned aerial systems (“sUAS”) and/or UAV platforms (collectively “UAV platforms”) to complete various missions.

In some embodiments, a UAV platform is configured to act as a mobile sensor in the sky overseeing grid operation 24/7 and integrating with other grid power electronics technologies. Information determined by artificial intelligence (AI) algorithms onboard the UAV can be reported back to operators of the T&D assets through wireless networks in real-time. The information can be combined and aggregated with other data sources such as smart grid devices, network sensors, etc. to build robust data models. The models can be used to create digital twins of the T&D assets. Deploying machine learning (ML) algorithms to the centralized database can produce a real-time digital twin of the assets, sifting through all sensor readings, and facilitate immediate intervention to inhibit or prevent faults in the grid.

### A. OVERVIEW

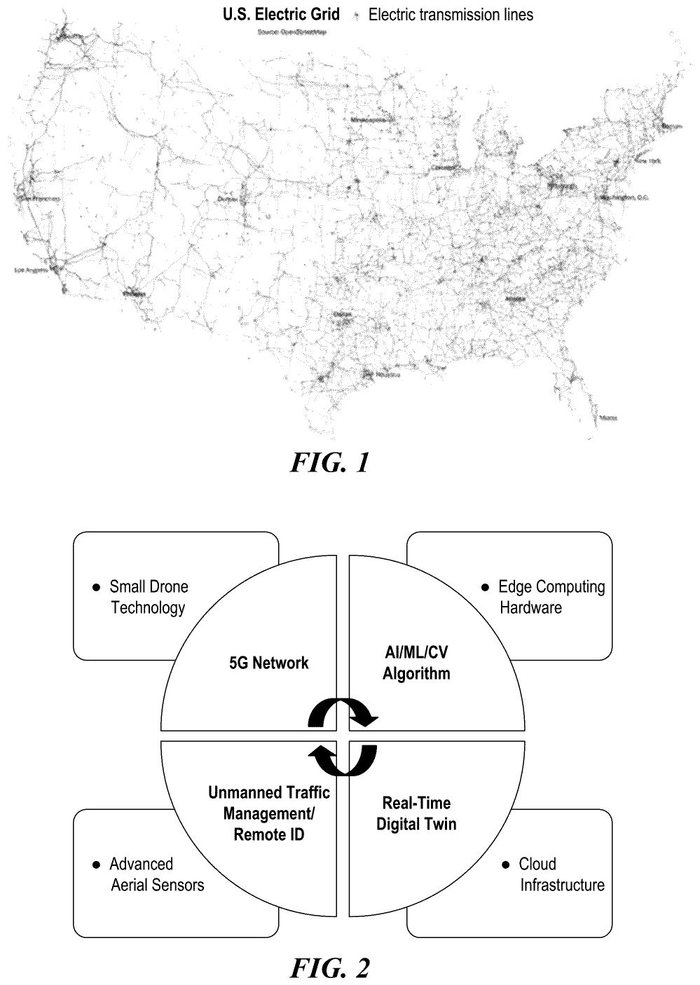

FIG. 1 shows a grid infrastructure specifically, the grid infrastructure of the United States) that can power a UAV platform configured in accordance with embodiments of the present technology. The UAV platform can facilitate broad access to all or substantially all of the grid infrastructure throughout, for example, a country (e.g., the United States). The present technology utilizes the existing powerline infrastructure (e.g., without or substantially without incurring any capital expenditure to build any new facilities) to power the UAV platforms of the present technology. For instance, the UAV platforms can be used to inspect and detect anomalies on the grid, and/or can be used to monitor, detect, and prevent wildfires (e.g., in California and Oregon) by flying around the grid and identifying heat spots on a frequent basis and informing stakeholders about the potential wildfire hazard to take preventative actions. Accordingly, several embodiments of the present technology operate at, around, and/or in the vicinity of the power grid infrastructure.

Embodiments of the present technology are expected to improve the reliability, resilience, and security of T&D assets through their advanced technology enabling capability which will translate into the digitization of T&D asset information, in order to detect and predict faults in real-time and/or provide a new communication and control layer in modern grid operation. Furthermore, embodiments of the present technology sit at the intersection of many other emerging technologies, as shown in FIG. 2, which illustrates several components of the Industry 4.0 industrial revolution.

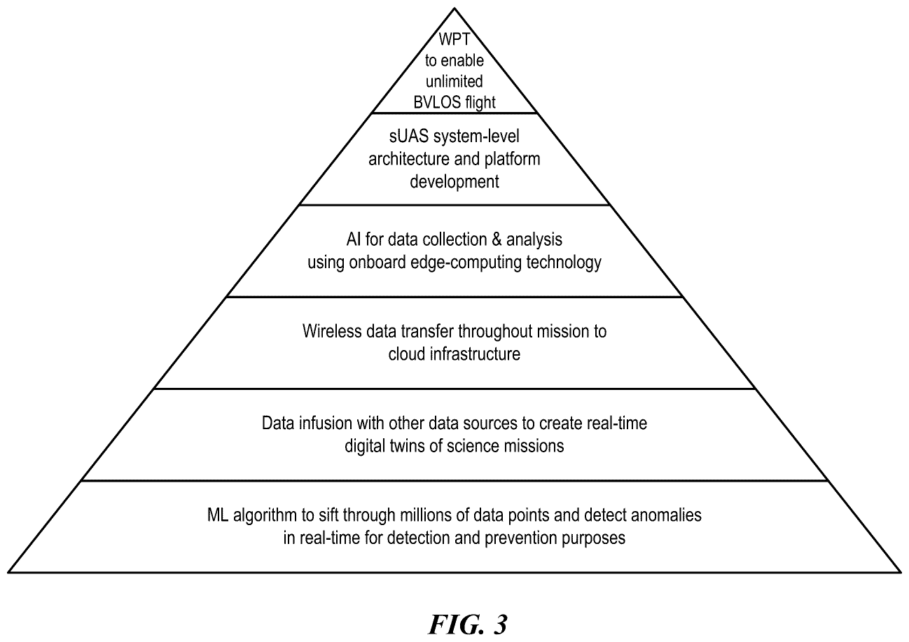

FIG. 3 is a diagram illustrating example technologies used in managing grid infrastructure in accordance with embodiments of the present technology. Embodiments of the present technology can include (i) ML algorithm(s) to sift through millions of data points and detect anomalies in real-time for detection and prevention purposes, (ii) data infusion with other data sources to create real-time digital twins of science missions, (iii) wireless data transfer to cloud infrastructure throughout a mission, (iv) AI for data collection and analysis using onboard edge-computing technology, and/or (v) wireless power transfer (WPT) units to enable unlimited (or otherwise extended) BVLOS flight.

The present technology includes several advantages related to WPT units including, for example:
1. Circuit level innovations that improve the efficiency and delivery of energy and reduce the sensitivity of the wireless power transfer system to environmental variants.
2. Receiver systems that can make use of both inductive and capacitive based wireless power transfer techniques with shared hardware. In addition, regulating induced power by dynamically adjusting the coupling factor can also be used to protect against overvoltage and control the flux when the transmission or distribution cables are at peak current levels.
3. Variable distance control that can control the level of coupling between the powerline and the UAV; e.g., reduce the coupling if the received power is more than is required. Such an approach can be implemented by adjusting the distance between a receiver coil of a UAV and a powerline.
4. Increasing the flux density in the receiver coil or plate using field guiding materials operated at designated points.
5. Using the same components as both electrical protecting materials and energy harvesting systems.

Several differentiating aspects of the present technology include:
1. The ability to harvest energy from electromagnetic fields surrounding ultra-low frequency (50 to 60 Hz) powerlines using WPT units.
2. A UAV configured to carry WPT units, optimize the weight-to-power ratio, and satisfy other mission requirements.
3. UAV navigation and control techniques for the purpose of power charging, flight control, and/or detection of anomalies.

In at least some embodiments, a UAV configured in accordance with embodiments of the present technology can include and/or be configured to perform one or more of the following:
1. Increased efficiency of magnetic coupling.
2. Shielding against extremely high electromagnetic fields.
3. Controlling the transfer of energy from a powerline to a WPT unit.
4. Guiding the UAV and/or the WPT unit in a controlled but autonomous manner to enhance (e.g., maximize) wireless charging power.
5. Small unmanned aerial vehicle systems equipped with WPT units and appropriate sensors to accomplish various missions using AI and/or ML technology for navigation and control, as well as detection and analysis of anomalies.
6. BVLOS flight and unlimited flight range using utility infrastructure as the energy source and transmitter.
7. Inspection and monitoring of utility infrastructure.
8. Fire detection and prevention at utility infrastructure, forests, etc.
9. Delivery of power or payloads.
10. Border surveillance.
11. Methods for digital transformation of assets, including T&D assets.

Compared to existing WPT units in which 1.5-2 W wireless power charging is delivered using distribution lines as wireless power transmitters, WPT units configured in accordance with the present technology can produce up to 250 W of power for a similar receiver coil weight. This is an approximately a 125× improvement. Because UAVs of the present technology can recharge while in flight/in operation, they can have reduced battery size/capacity/weight compared to other UAVs, without or substantially without reducing operating efficiency. Accordingly, UAVs including WPT units configured in accordance with embodiments of the present technology can have an increased power-to-weight ratio, and can deploy technology for monitoring, inspection, reconnaissance, delivery, and/or other purposes for longer flight times.

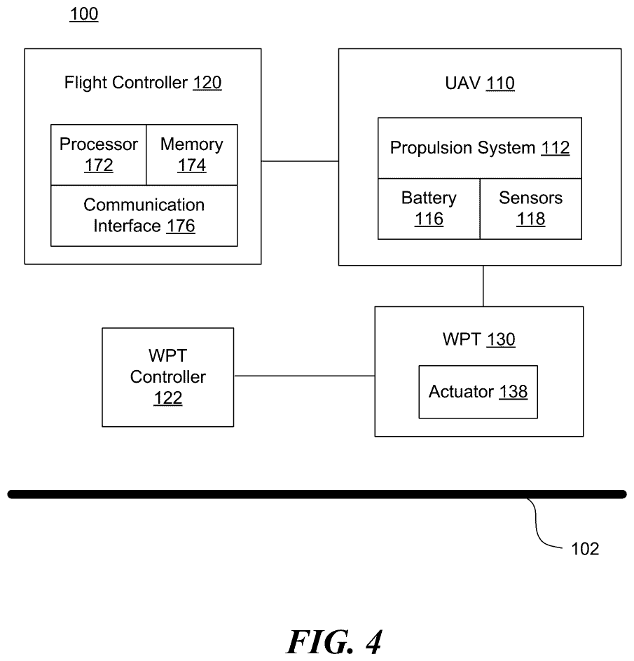

FIG. 4 is a schematic of an unmanned aerial vehicle system 100 (“system 100”) in accordance with embodiments of the present technology. The system 100 can include a UAV 110, a WPT unit 130 carried by the UAV 110, a flight controller 120 (e.g., a microcontroller or other processing unit) for controlling the UAV 110, and a WPT controller 122 (e.g., a microcontroller or other processing unit) for controlling the WPT unit 130. Elements of the flight controller 120 can be carried by the UAV 110, and/or can be located off-board the UAV 110. In some embodiments, the UAV 110 can include a propulsion system 112 (e.g., including rotors, motors, etc.), a battery (and/or other energy storage device) 116, and/or one or more sensors 118. The sensors 118 can include sensors for measuring various characteristics of the battery (e.g., current flowing into the battery, remaining charge, voltage level), sensors for collecting information about the environment (e.g., thermal cameras, optical cameras, machine vision cameras), etc. The WPT unit 130 can include one or more actuators 138 positioned to move one or more other components of the WPT unit 130, as described in further detail below. The battery 116 can provide power to the propulsion system 112, the sensors 118, and/or the actuators 138. The system can further include an actuator positioned to move the WPT unit relative to the UAV.

During operation, the UAV 110 carrying the WPT unit 130 can be positioned proximate to a powerline 102 (e.g., a high-voltage powerline or other source of energy) via the flight controller 120 and the propulsion system 112. The sensors 118 can detect where to position the UAV 110 relative to the powerline 102. In some embodiments, the WPT unit 130 can be attached to the UAV at a generally fixed position and the flight controller 120 can move both the UAV 110 and the WPT unit 130 toward the powerline 102 until the WPT unit 130 engages the powerline 102. In some embodiments, an actuator included in the UAV 110 can move the WPT unit 130 closer to the powerline 102 while the UAV 110 remains at a distance away from the powerline 102 (e.g., to reduce the risk of the UAV itself contacting the powerline 102).

In some embodiments, the WPT controller 122 can move the WPT unit 130 relative to the UAV 110. In some embodiments, the WPT controller 122 can control the actuators 138 to engage the powerline 102. The WPT unit 130 can then charge the UAV 110 (e.g., by directing current to the battery 116) using the powerline 102 via inductive power transfer (IPT) and/or capacitive power transfer (CPT). Afterward, the WPT controller 122 can disengage the WPT unit 130 from the powerline 102 and the flight controller 120 can position the UAV 110 to move away from the powerline 102 (e.g., to continue a mission).

The system 100 can be customized depending on the mission requirements and design limitations specific to certain use cases. For example, certain components (e.g., computer, sensors, mechanical components, electronics, etc.) can be selected and integrated based on weight, energy consumption, form factors, computing power, etc. In some embodiments, the flight controller 120 and/or the WPT controller 122 can be controlled according to custom software instructions. In some embodiments, some components can be used for multiple functions. For example, the same sensors 118 can be used for both navigation and utility infrastructure inspection, reducing the total weight of the system 100.

The flight controller 120 can include a processor 172, a memory 174, a communication interface 176, an internal interface (not shown), or other internal components used to implement one or more functions of the UAV 110. The memory 174 can include instructions that, when executed by the processor 172, controls one or more components in the UAV to implement functions or actions. For example, the memory 174 can include instructions for engaging/disengaging the WPT unit 130, positioning the UAV 110 and/or the WPT unit 130 during a charging operation for the battery 116, flight operations, and other similar functions. The processor 172 and the memory 174 can be used to implement the AI/ML/CV algorithm described above. Further, the processor 172 and the memory 174 can correspond to the edge computing hardware, cloud computing component, and the like described above. Some examples of the memory 174 can include recordable-type media such as volatile (e.g., random memory, cache memory, etc.) and non-volatile memory devices (e.g., Flash memory, read-only memory, etc.), floppy and other removable disks, hard disk drives, optical disks (e.g., Compact Disk Read-Only Memory (CD ROMS), Digital Versatile Disks (DVDs)), and transmission-type media such as digital and analog communication links.

The communication interface 176 can include circuitry (e.g., a transceiver) configured to communicate signals to and from a device external to the UAV 110. In some embodiments, the communication interface 176 can include a wireless transceiver configured to communicate signals according to one or more predetermined protocols. Some example communication protocols can include Bluetooth, WiFi, wireless mobile/cellular network standards (e.g., fifth-generation or 5G cellular), dedicated point-to-point communication (e.g., targeted frequency or code, laser or infrared signaling, etc.).

### B. SELECT WPT UNIT EMBODIMENTS

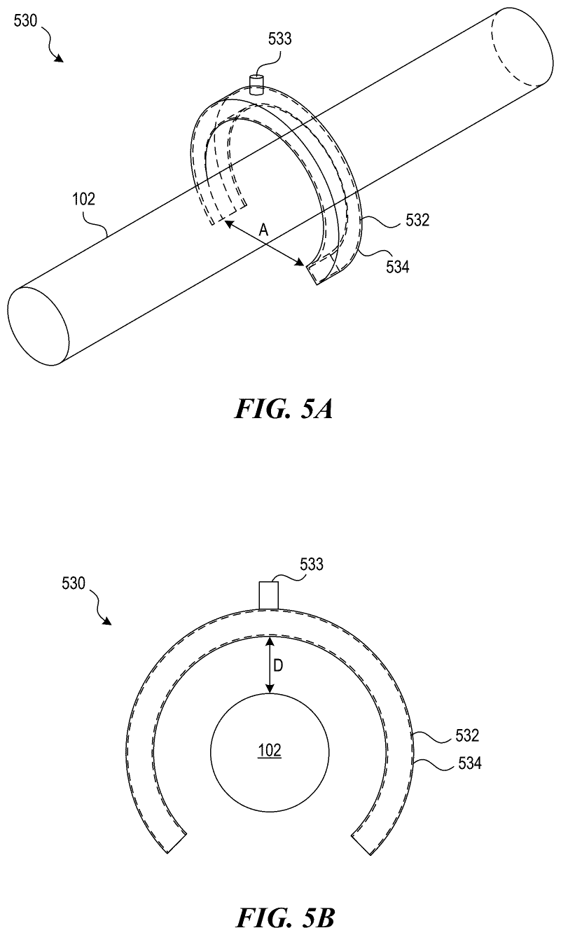

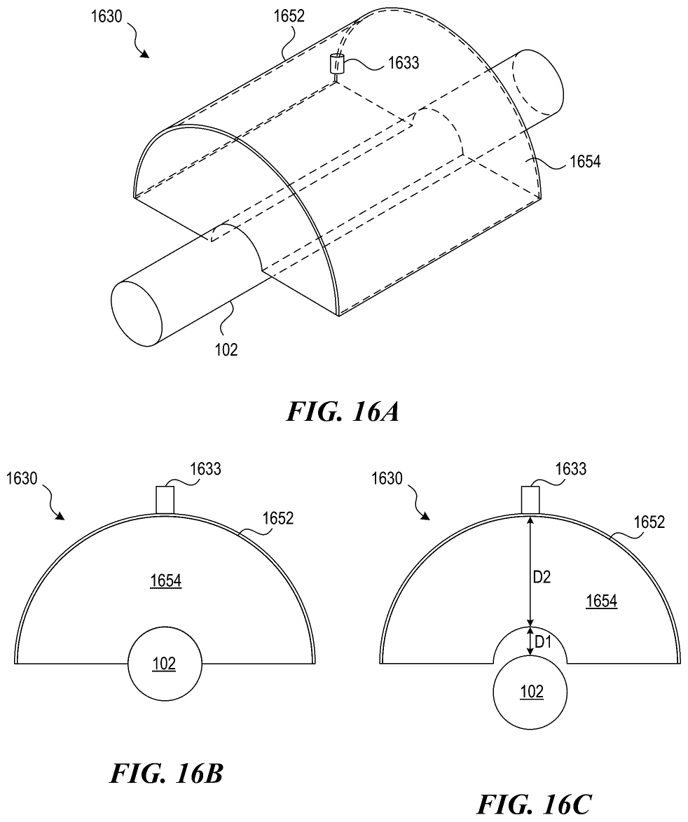

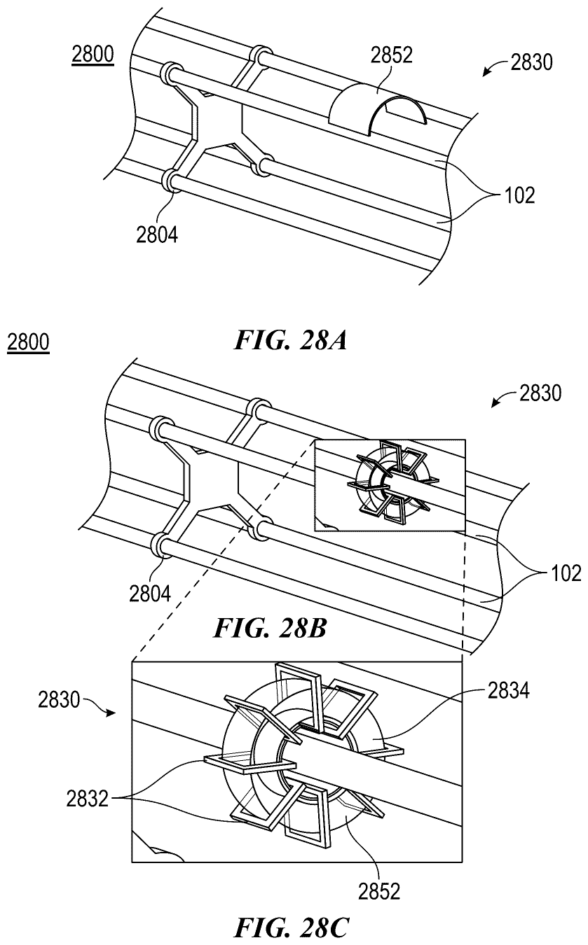

FIGS. 5A-15C illustrate various WPT unit designs that can provide an inductive power transfer from a powerline to a UAV. FIGS. 16A-C illustrate WPT units that can provide a capacitive power transfer from a powerline to a UAV. Further embodiments provide combined inductive and capacitive power transfer, as described below with reference to FIGS. 28B-C. Embodiments of the present technology can be configured to deliver real-time charging for inflight aerial devices and/or a steady-state high-performance charging scenario in which the aerial device remains generally or substantially stationary, e.g., “locked” in place relative to a powerline. Any of the embodiments described herein may comprise WPT circuitry, a UAV interfacing portion or support (e.g., fasteners, holes for receiving such fasteners, magnets, rods, tethers, actuators), flight controls, and/or actuation controls.

WPT unit embodiments providing inductive power transfer (e.g., FIGS. 5A-15C) can each comprise an induction coil and one or more field guiding portions. The induction coil can be disposed proximate to (e.g., wound around) at least one of the field guiding portions. In some embodiments, an insulating material (e.g., rubber, electrical tape) can be disposed between the induction coil and the field guiding portions. The alternating current traversing through a powerline induces a change in a magnetic field about the powerline. The magnetic field and the changes thereof are received or channeled through the field guiding portions. The induction coil can be configured or wound about the field guiding portions such that the changes in the magnetic field/force received through the field guiding portions cause a current flow through the induction coil. The field guiding portions can include materials (e.g., a ferrite material, a ferrous material, a high permeability material, and/or other suitable material such as steel 1010, steel 1018, nanocrystalline, silicon steel grade B23) that guide a magnetic and/or electric field toward the induction coil, increasing the efficiency of the inductive coupling. For example, the field guiding portions can increase the concentration of the magnetic field that is passing through the induction coil and increase the coupling coefficient between the powerline (transmitter) and the induction coil (receiver). The resulting current output from the WPT unit can be provided to a power regulator circuit, a rectifier circuit, and/or the like for preconditioning. The UAV can utilize the preconditioned power (e.g., result of the electro-magnetic coupling between the WPT unit and the powerline) to (1) power the motor/propulsion system 112 of FIG. 4, (2) power other circuits/loads internal to the UAV (e.g., the processor 172, the sensors 118 of FIG. 4, etc.), (3) charge the onboard battery 116 of FIG. 4, and/or combinations thereof.

WPT unit embodiments providing capacitive power transfer (e.g., FIGS. 16A-C) can each comprise a capacitive plate and a dielectric material having high permittivity. The use of the dielectric material can increase the capacitive coupling between the capacitor plate and the powerline, inhibit or prevent voltage breakdown (arc), and/or shield the UAV from high electric fields presented at or near the high voltage powerlines.

A person of ordinary skill in the art will appreciate that UAVs can carry one or more of any of the WPT unit designs described herein, e.g., multiple of any one WPT design and/or individual ones of two or more of the WPT unit designs. For example, a UAV can carry a WPT unit with both inductive and capacitive power transfer designs.

B.1 Horseshoe Design

FIGS. 5A-B are perspective and front views, respectively, of a WPT unit 530 with a “horseshoe” design in accordance with embodiments of the present technology. The WPT unit 530 can include an induction coil 532 electrically connected to a UAV (e.g., the battery of the UAV), a field guiding portion 534 disposed proximate to the induction coil 532 (e.g., within the loops of the induction coil 532), and a UAV interfacing portion or support 533 attached to the field guiding portion 534. For purposes of illustration and simplicity in FIGS. 5A-B and other figures herein, the induction coil 532 is illustrated schematically without identifying individual loops of the coil. The field guiding portion 534 can have a shape corresponding to a partial-ring, as shown. In other embodiments, the field guiding portion 534 can have other geometries (e.g., a partial-oval, a partial-rectangle, a partial-triangle).

To transfer power from the powerline 102 to the UAV, the WPT unit 530 can be moved toward the powerline 102 until the field guiding portion 534 at least partially encircles the powerline 102. For example, the WPT unit 530 can be positioned such that the powerline 102 is disposed within (e.g., at the center of) the horseshoe shape of the field guiding portion 534. A magnetic field generated by current flowing in the powerline 102 can induce a current through the induction coil 532, allowing the UAV (e.g., a battery of the UAV) to be inductively charged by the powerline 102 via the WPT unit 530. In some embodiments, the rate of inductive charging can be controlled by changing a distance D between the induction coil 532 and the powerline 102. For example, the WPT unit 530 can be moved relative to the powerline 102 via a flight controller (e.g., the flight controller 120) and/or a WPT controller (e.g., the WPT controller 122).

The open airgap A of the horseshoe design can be sized to control the operating point of the field guiding portion 534 (e.g., a ferrous material) to improve (e.g., optimize) the effectiveness of the field guiding portion, resulting in a high receiver inductance and leading to a small (e.g., light weight) capacitive component suitable for avionics applications. Material characteristics are described in further detail below under Section F.1. By sizing the gap to be larger in the horseshoe design, the thickness of the coil can be reduced significantly, reducing the UAV's total weight at the cost of a lower power transfer efficiency.

B.2 Clamp Design

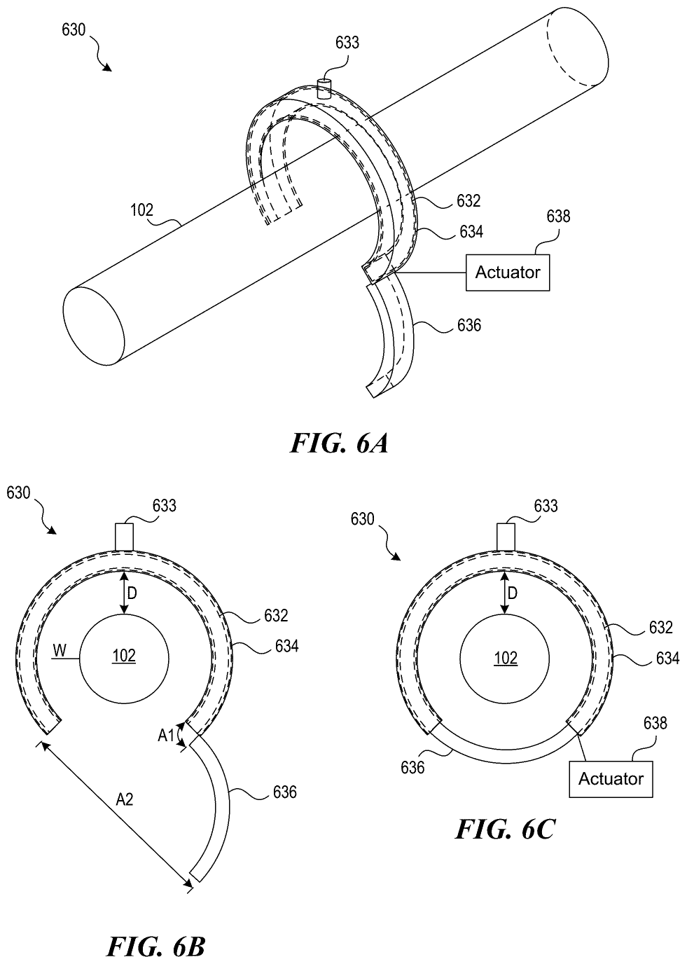

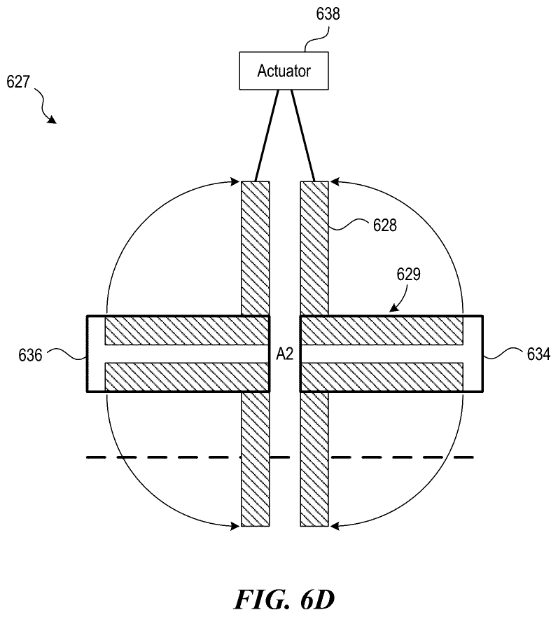

FIG. 6A is a perspective view of a WPT unit 630 with a “clamp” design in an open position in accordance with embodiments of the present technology. FIGS. 6B and 6C are front views of the WPT unit 630 in the open position and in a closed position, respectively. The WPT unit 630 can include an induction coil 632 electrically connected to a UAV (e.g., the battery of the UAV), a first field guiding portion 634 disposed proximate to the induction coil 632, a second field guiding portion 636 operatively coupled to the first field guiding portion 634 (e.g., via a hinge or pivot), a UAV interfacing portion 633 attached to the first field guiding portion 634 and configured to be attached to the UAV, and an actuator 638 operatively coupled to at least one of the first or second field guiding portions 634, 636. Each of the first and second field guiding portions 634, 636 can have a shape corresponding to a partial-ring, as shown. In other embodiments, each of the first and second field guiding portions 634, 636 can have other geometries (e.g., a partial-oval, a partial-rectangle, a partial-triangle).

To transfer power from the powerline 102 to the UAV, the WPT unit 630 can be moved toward the powerline 102 while in the open position (FIGS. 6A and 6B) until the first field guiding portion 634 at least partially encircles the powerline 102. For example, the WPT unit 630 can be positioned such that the powerline 102 is disposed within (e.g., at the center of) the geometry of the first field guiding portion 634. A magnetic field generated by current flowing in the powerline 102 can induce a current through the induction coil 632, allowing the UAV (e.g., a battery of the UAV) to be inductively charged by the powerline 102 via the WPT unit 630. In some embodiments, the rate of inductive charging can be controlled by changing a distance D between the induction coil 632 and the powerline 102. For example, the WPT unit 630 can be moved relative to the powerline 102 via a flight controller (e.g., the flight controller 120) and/or a WPT controller (e.g., the WPT controller 122).

In some embodiments, the rate of inductive charging can also be controlled by changing the size of the first and/or second airgaps A1, A2 between the first and second field guiding portions 634, 636 via the actuator 638. In some embodiments, each of the first and second airgaps A1, A2 can be maintained at less than 5 cm while charging. The actuator 638 can move one of the first or second field guiding portions 634, 636 toward or away the other (e.g., via rotation about a hinge or pivot) to decrease or increase, respectively, the first and/or second airgaps A1, A2. Increasing the first and/or second airgaps A1, A2 can increase the reluctance to the magnetic field, thereby reducing the density of the magnetic field in the first and/or second field guiding portions 634, 636. Conversely, decreasing the first and/or second airgaps A1, A2 can decrease the reluctance to the magnetic field, thereby increasing the density of magnetic field in the first and/or second field guiding portions 634, 636. In some embodiments, changing the distance D and/or the first and second airgaps A1, A2 can be automated by a feedback loop system, e.g., to obtain a target operating point. The feedback loop system can be implemented via one or more of the components shown in FIG. 4, e.g., the flight controller 120, the WPT controller 122, the propulsion system 112, and/or the sensors 118, as well as the actuator 638. For example, if the sensors detect that the rate of inductive charging is too high (e.g., raising efficiency and safety concerns), the controllers can control the propulsion system and/or the actuator 638 to increase the distance D and/or the first and/or second airgaps A1, A2, respectively. Conversely, if the sensors detect that the rate of inductive charging is too low (e.g., too time-consuming), the controllers can control the propulsion system and/or the actuator 638 to decrease the distance D and/or the first and/or second airgaps A1, A2, respectively.

To cease power transfer from the powerline 102 (e.g., when the charging process is complete, and/or when the UAV must continue a mission), the actuator 638 can move the second field guiding portion 636 away from the first field guiding portion 634 such that the WPT unit 630 unclamps (FIG. 6B) via, for example, a rotating or pivoting motion. The WPT unit 630 can then move up (e.g., closer to the UAV) and/or switch to the closed position (FIG. 6C) for improved aerodynamic performance during flight.

FIG. 6D is an enlarged sectional view of an airgap control assembly 627 configured in accordance with embodiments of the present technology. In some embodiments, the WPT circuitry can generate and control a magnetic force between the first and second guiding portions 634, 636 (e.g., at the first and/or second airgaps A1, A2) in order to increase the coupling between first and second guiding portions 634, 636 (e.g., while charging) or decrease the coupling (e.g., when disengaging the WPT unit 630 from the powerline 102). In some embodiments, the ends of the first and second guiding portions 634, 636 at the second airgap A2 can be flared (e.g., can have an increased surface area) or actuated to become flared before and/or during charging in order to increase the surface area of the components at the second airgap A2, which can reduce the electromagnetic force therebetween, as will be described in further detail below under Section E.2.

In the illustrated embodiment, the airgap control assembly 627 includes eight flaps 628 that can switch between a retracted state and an extended state. On each of the first and second field guiding portions 634, 636, four flaps 628 are attached, two of which are shown extending upward and downward, and the other two extending into or out of the page. Each flap 628 can be attached to a different side or portion on each of the first and second field guiding portions 634, 636. In the retracted state, the flaps 628 can be oriented along the first and second field guiding portions 634, 636 in flap storing portions 629. In the extended state, the flaps 628 can be deployed and oriented generally perpendicular to the flap orientation in the retracted state. The flaps 628 can increase the effective surface area at the second airgap A2. In some embodiments, the flaps 628 can be actuated between the retracted and extended states by the actuator 638 or a different actuator. In some embodiments, the airgap control assembly 627 can include a biasing member (e.g., a spring) positioned to push the flaps 628 toward the extended state such that the actuator can operate to pull the flaps 628 toward the retracted state, or vice versa. In some embodiments, the airgap control assembly 627 can include a different number of flaps and/or include flaps arranged differently.

B.3 Hollow Design

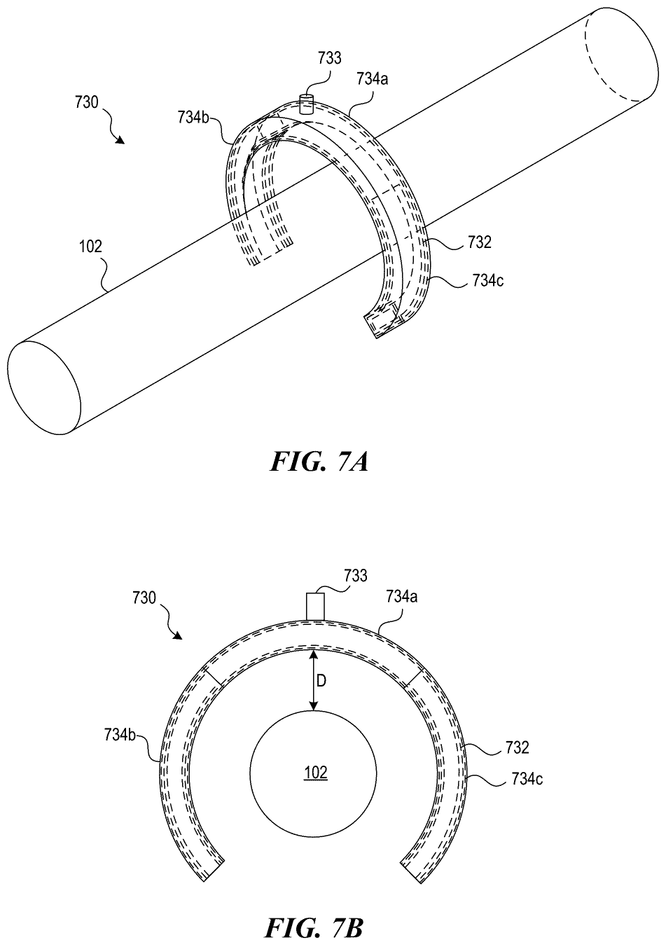

FIGS. 7A and 7B are perspective and front views, respectively, of a WPT unit 730 with a “hollow” design in accordance with embodiments of the present technology. The WPT unit 730 can include an induction coil 732 electrically connected to a UAV (e.g., the battery of the UAV), a central field guiding portion 734a disposed proximate to the induction coil 732, a first leg field guiding portion 734b attached to a first end of the central field guiding portion 734a, a second leg field guiding portion 734c attached to a second end of the central field guiding portion 734a opposite the first end, and a UAV interfacing portion 733 attached to the field guiding portion 734. Each of the central, first leg, and second leg field guiding portions 734a/b/c can have a shape corresponding to a partial-ring, as shown. In other embodiments, each of the central, first leg, and second leg field guiding portions 734a/b/c can have other geometries (e.g., a partial-oval, a partial-rectangle, a partial-triangle). In some embodiments, the central, first leg, and second leg field guiding portions 734a/b/c can be integrally formed. In some embodiments, the central, first leg, and second leg field guiding portions 734a/b/c can be separate components that are mechanically (e.g., via fasteners) and/or magnetically attached. One or more of the central, first leg, and second leg field guiding portions 734a/b/c can be at least partially hollowed out.

In the illustrated embodiment, the WPT unit 730 operates generally similarly to that of the horseshoe designed shown and described above with respect to FIGS. 5A-C. The hollowed out portions of the WPT unit 730 provide weight reduction, which can result in lower power consumption by the UAV and/or the WPT unit 730. In some embodiments, parts of the central, first leg, and second leg field guiding portions 734a/b/c that naturally receive magnetic fields of lower concentration can be hollowed out to achieve the same operating point (e.g., permeability) as the rest of the central, first leg, and second leg field guiding portions 734a/b/c. This can lead to a more lightweight WPT unit 730 compared to the horseshoe design while maintaining a similar degree of overall performance.

B.4 Rotational Design

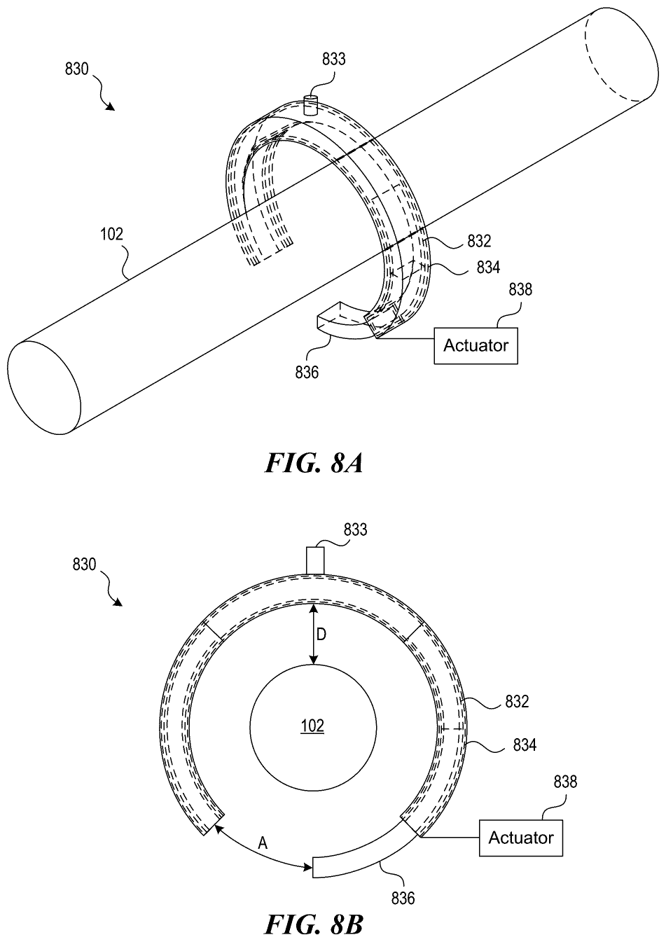

FIGS. 8A and 8B are perspective and front views, respectively, of a WPT unit 830 with a “rotational” design in accordance with embodiments of the present technology. The WPT unit 830 can include an induction coil 832 electrically connected to a UAV (e.g., the battery of the UAV), a first field guiding portion 834 disposed proximate to the induction coil 832 and having a cavity (e.g., a hollowed out portion), a second field guiding portion 836 positioned to move at least partially into and out of the cavity of the first field guiding portion 834, a UAV interfacing portion 833 attached to the first field guiding portion 834, and an actuator 838 operatively coupled to at least one of the first or second field guiding portions 834, 836. Each of the first and second field guiding portions 834, 836 can have a shape corresponding to a partial-ring, as shown. In other embodiments, each of the first and second field guiding portions 834, 836 can have other geometries.

To transfer power from the powerline 102 to the UAV, the WPT unit 830 can be moved toward the powerline 102 while an airgap A between the first and second field guiding portions 834, 836 is greater than a diameter of the powerline 102, and until the first field guiding portion 834 at least partially encircles the powerline 102. For example, the WPT unit 830 can be positioned such that the powerline 102 is disposed within (e.g., at the center of) the geometry of the first field guiding portion 834. A magnetic field generated by current flowing in the powerline 102 can induce a current through the induction coil 832, allowing the UAV (e.g., a battery of the UAV) to be inductively charged by the powerline 102 via the WPT unit 830. In some embodiments, the rate of inductive charging can be controlled by changing a distance D between the induction coil 832 and the powerline 102. For example, the WPT unit 830 can be moved relative to the powerline 102 via a flight controller (e.g., the flight controller 120) and/or a WPT controller (e.g., the WPT controller 122).

In some embodiments, the rate of inductive charging can also be controlled by changing the size of the airgap A via the actuator 838. The actuator 838 can move (e.g., slidably move) the second field guiding portion 836 at least partially into and out of the cavity to increase or decrease, respectively, the airgap A. Increasing the airgap A can increase the reluctance to the magnetic field, thereby reducing the density of the magnetic field in the first and/or second field guiding portions 834, 836. Conversely, decreasing the airgap A can decrease the reluctance to the magnetic field, thereby increasing the density of magnetic field in the first and/or second field guiding portions 834, 836. In some embodiments, changing the distance D and/or the airgap A can be automated by a feedback loop system, e.g., to obtain a target operating point, as discussed above with respect to FIGS. 6A-C.

To cease power transfer from the powerline 102, the actuator 838 can move the second field guiding portion 836 such that airgap A is greater than the diameter of the powerline 102. The WPT unit 830 can then move up (e.g., closer to the UAV) for improved aerodynamic performance during flight.

B.5 Clamp Lock Design

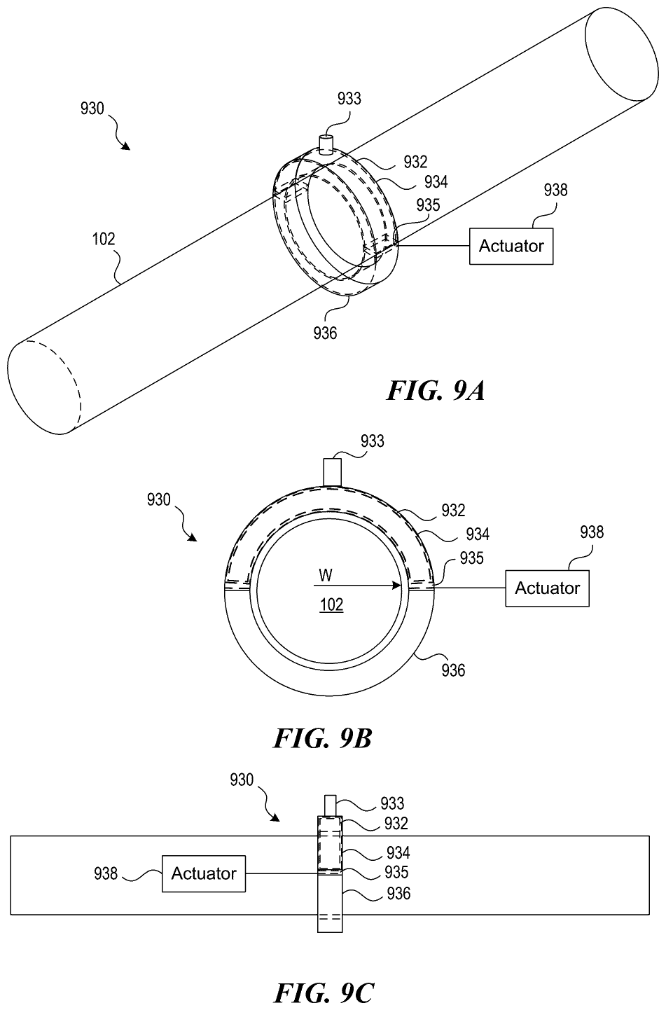

FIGS. 9A-C are perspective, front, and side views, respectively, of a WPT unit 930 with a “clamp lock” design in accordance with embodiments of the present technology. The WPT unit 930 can include an induction coil 932 electrically connected to a UAV (e.g., the battery of the UAV), a first field guiding portion 934 disposed proximate to the induction coil 932, a second field guiding portion 936 operatively coupled to the first field guiding portion 934 (e.g., via a hinge or pivot), an interface 935 between the first and second field guiding portions 934, 936, a UAV interfacing portion 933 attached to the first field guiding portion 934, and an actuator 938 operatively coupled to at least one of the first or second field guiding portions 934, 936. Each of the first and second field guiding portions 934, 936 can have a shape corresponding to a partial-ring, as shown. In some embodiments, the first and second field guiding portions 934, 936 can have an inner diameter generally similar to a diameter of the powerline 102 such that the WPT unit 930 (i) grips the powerline 102 and provides stability during charging, and (ii) is smaller and more lightweight compared to embodiments in which a gap is provided between the WPT unit and the powerline (e.g., FIGS. 6A-C). In other embodiments, each of the first and second field guiding portions 934, 936 can have other geometries (e.g., a partial-oval, a partial-rectangle, a partial-triangle).

In some embodiments, the clamp lock design can operate in a manner similar to the clamp design shown in and described above with respect to FIGS. 6A-C. For example, to transfer power from the powerline 102 to the UAV, the WPT unit 930 can be moved toward the powerline 102 while in an open position (see, e.g., FIGS. 6A and 6B) until the first field guiding portion 934 at least partially encircles the powerline 102. An actuator 938 can then bring the second field guiding portion 936 toward the first field guiding portion 934. A magnetic field generated by current flowing in the powerline 102 can induce a current through the induction coil 932, allowing the UAV (e.g., a battery of the UAV) to be inductively charged by the powerline 102 via the WPT unit 930. In some embodiments, the first and second field guiding portions 934, 936 can generate an attractive magnetic force at an airgap A that pulls the first and second field guiding portions 934, 936 toward one another to ensure that the WPT unit 930 encircles the powerline 102 while charging.

In some embodiments, the rate of inductive charging can be controlled by changing the size of an airgap at the interface 935 via the actuator 938 and therefore the magnitude of the magnetic force. For example, one of the first or second field guiding portions 934, 936 can be moved toward or away the other to decrease or increase, respectively, the airgap A. In some embodiments, changing the airgap A can be automated by a feedback loop system, e.g., to obtain a target operating point, as discussed above with respect to FIGS. 6A-C.

To cease power transfer from the powerline 102, the actuator 938 can move the second field guiding portion 936 away from the first field guiding portion 934 such that the WPT unit 930 unclamps via, for example, a rotating or pivoting motion. WPT circuitry can also cease generating the attractive magnetic force or create a repelling magnetic force (e.g., by reversing the magnetic field) to ease disengagement of the first and second field guiding portions 934, 936. The WPT unit 930 can then move up (e.g., closer to the UAV) and/or switch to the clamped position (as shown) for improved aerodynamic performance during flight.

B.6 Non-Straight Rail Design

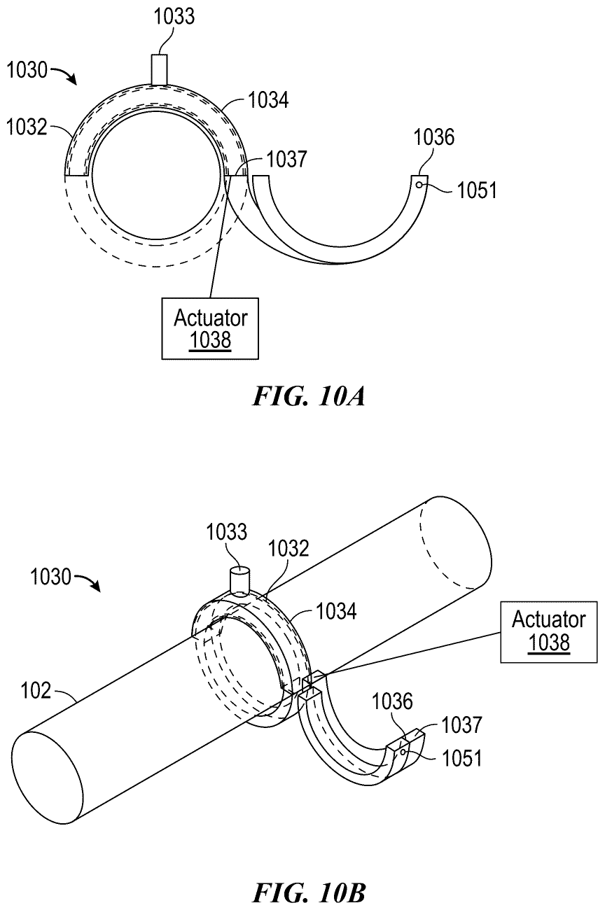

FIGS. 10A and 10B are front and perspective views, respectively, of a WPT unit 1030 with a “non-straight rail” design in accordance with embodiments of the present technology. The WPT unit 1030 can include an induction coil 1032 electrically connected to a UAV (e.g., the battery of the UAV), a first field guiding portion 1034 disposed proximate to the induction coil 1032, a second field guiding portion 1036 operatively coupled to the first field guiding portion 1034, a UAV interfacing portion 1033 attached to the first field guiding portion 1034, a rail 1037 on which the second field guiding portion 1036 is carried (e.g., via pin 1051 or other coupling mechanisms), and an actuator 1038 operatively coupled to the second field guiding portion 1036 and/or the rail 1037. Each of the first and second field guiding portions 1034, 1036 can have a shape corresponding to a partial-ring, as shown. In other embodiments, each of the first and second field guiding portions 1034, 1036 can have other geometries (e.g., a partial-oval, a partial-rectangle, a partial-triangle). The rail 1037 can be attached to the UAV and can have a curved geometry, as shown, allowing the second field guiding portion 1036 to move along the rail 1037 via the pin 1051 without hitting the powerline 102. In other embodiments, the rail 1037 can have other non-straight geometries (e.g., resembling three sides of a rectangle, a V-shape). The second field guiding portion 1036 may or may not be rotated relative to the first field guiding portion 1034 while moving along the rail 1037.

To transfer power from the powerline 102 to the UAV, the WPT unit 1030 can be moved toward the powerline 102 while the second field guiding portion 1036 is at a position on the rail 1037 away from the first field guiding portion 1034 (e.g., to the right of the powerline 102, and until the first field guiding portion 1034 at least partially encircles the powerline 102. The second field guiding portion 1036 is then moved to the left along the rail 1037 (e.g., coupled via fasteners) to enclose or more fully enclose the powerline 102. A magnetic field generated by current flowing in the powerline 102 can induce a current through the induction coil 1032, allowing the UAV (e.g., a battery of the UAV) to be inductively charged by the powerline 102 via the WPT unit 1030.

In some embodiments, the rate of inductive charging can be controlled by changing the distance between the first and second field guiding portions 1034, 1036 via the actuator 1038. The actuator 1038 can move the second field guiding portion 1036 along the rail 1037 toward or away the first field guiding portion to decrease or increase, respectively, the distance. In some embodiments, changing the distance can be automated by a feedback loop system, e.g., to obtain a target operating point, as discussed above with respect to FIGS. 6A-C.

To cease power transfer from the powerline 102, the actuator 1038 can move the second field guiding portion 1036 away from the first field guiding portion 1034 along the rail 1037. The WPT unit 1030 can then move up (e.g., closer to the UAV) and/or move the second field guiding portion 1036 back toward the first field guiding portion 1034 for improved aerodynamic performance during flight.

B.7 Straight Rail Design

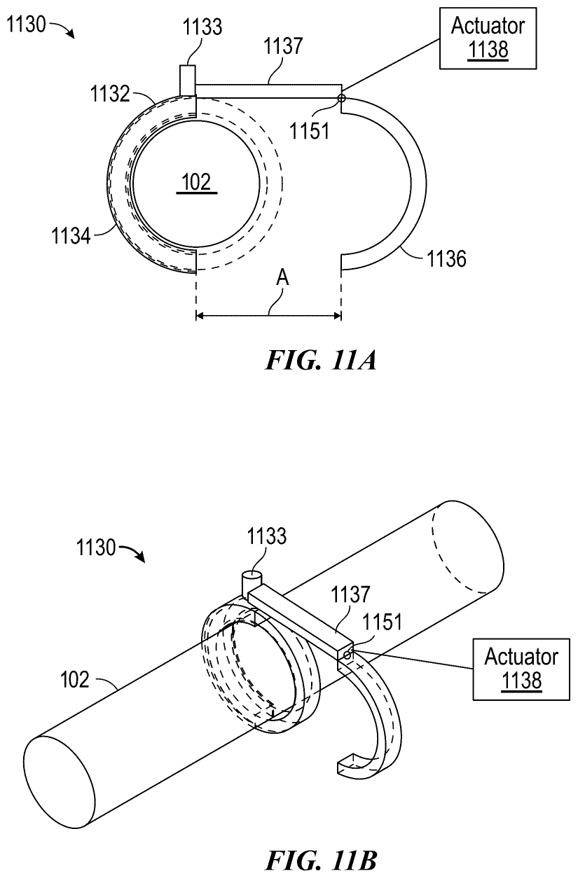

FIGS. 11A and 11B are front and perspective views, respectively, of a WPT unit 1130 with a “straight rail” design in accordance with embodiments of the present technology. The WPT unit 1130 can include an induction coil 1132 electrically connected to a UAV (e.g., the battery of the UAV), a first field guiding portion 1134 disposed proximate to the induction coil 1132, a second field guiding portion 1136 operatively coupled to the first field guiding portion 1134, a UAV interfacing portion 1133 attached to the first field guiding portion 1134, a rail 1137 on which the second field guiding portion 1136 is carried (e.g., via pin 1151 or other coupling mechanisms), and an actuator 1138 operatively coupled to the second field guiding portion 1136 and/or the rail 1137. Each of the first and second field guiding portions 1134, 1136 can have a shape corresponding to a partial-ring, as shown. In other embodiments, each of the first and second field guiding portions 1134, 1136 can have other geometries (e.g., a partial-oval, a partial-rectangle, a partial-triangle).

In contrast to the embodiment illustrated in FIGS. 10A-B, the rail 1137 can have a straight geometry, as shown, allowing the second field guiding portion 1136 to move along the rail 1137 via the pin 1151 toward or away from powerline 102 and/or the first field guiding portion 1134. Operation of the straight rail design can be generally similar to the operation of the non-straight rail design described above.

B.8 Double Lock Design

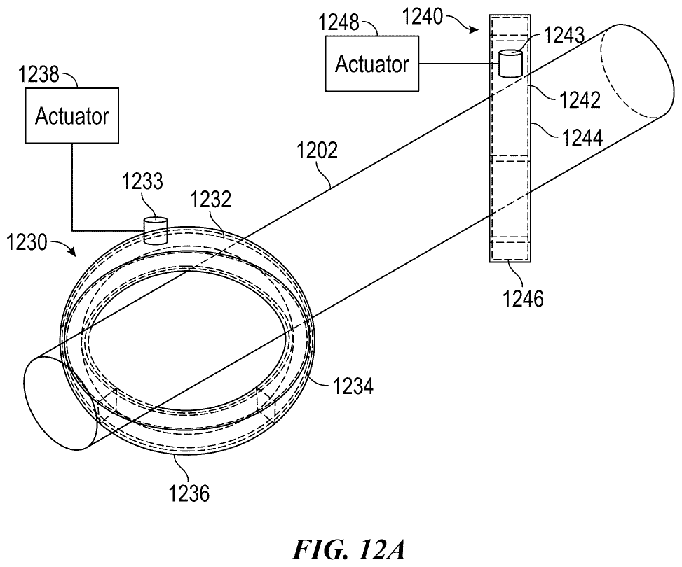

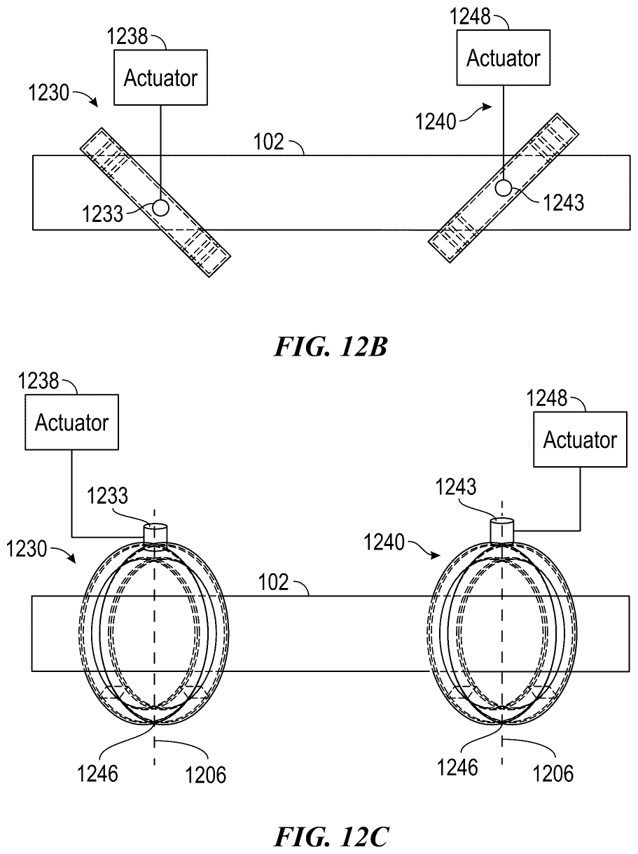

FIGS. 12A-C are perspective, top, and side views, respectively, of a first WPT unit 1230 and a second WPT unit 1240 with a “double lock” design in accordance with embodiments of the present technology. The first WPT unit 1230 can include a first induction coil 1232 electrically connected to a UAV (e.g., the battery of the UAV), a first field guiding portion 1234 disposed proximate to the first induction coil 1232, a second field guiding portion 1236 operatively coupled to the first field guiding portion 1234, a first UAV interfacing portion 1233 attached to the first field guiding portion 1234, and a first actuator 1238 operatively coupled to at least one of the first or second field guiding portions 1234, 1236. The second WPT unit 1240 can include a second induction coil 1242 connected to the same UAV, a third field guiding portion 1244 disposed proximate to the second induction coil 1242, a fourth field guiding portion 1246 operatively coupled to the third field guiding portion 1244, a second UAV interfacing portion 1243 attached to the third field guiding portion 1244, and a second actuator 1248 operatively coupled to at least one of the third or fourth field guiding portions 1244, 1246.

Each of the first and second WPT units 1230, 1240 can comprise any suitably configured one (or more) of the WPT unit designs shown and described herein in which the inner diameter (or inner dimension) is larger than a diameter of powerline 102, such that there is a gap between each of the first and second WPT units 1230, 1240 and the powerline 102. The first and second WPT units 1230, 1240 can comprise same or different WPT unit designs.

To transfer power from the powerline 102 to the UAV, the first and second WPT units 1230, 1240 can be moved to at least partially encircle the powerline 102. The first and second actuators 1238, 1248 can then rotate the first and second WPT units 1230, 1240, respectively, about their yaw axes 1206 (FIG. 12C), which extend generally perpendicular to the powerline 102. FIGS. 12A-C illustrate the first and second WPT units 1230, 1240 rotated about their yaw axes by approximately 45 degrees in opposite directions. In other embodiments, the first and second WPT units 1230, 1240 can be rotated about their yaw axes by different angles and/or in the same direction. Rotating each of the first and second WPT units 1230, 1240 causes portions of the inner diameter to contact the powerline 102. In the illustrated embodiment, each WPT unit includes two portions of the inner diameter contacting opposite sides of the powerline 102, effectively gripping the powerline 102. The grip can provide stability for the UAV while the first and second WPT units 1230, 1240 transfer power.

To cease power transfer from the powerline 102, the first and second actuators 1038, 1048 can rotate the first and second field guiding portions 1234, 1236, respectively, about the yaw axis in the opposite direction. The first and second WPT units 1230, 1240 can then move up (e.g., closer to the UAV) for improved aerodynamic performance during flight.

B.9 Triple Lock Design

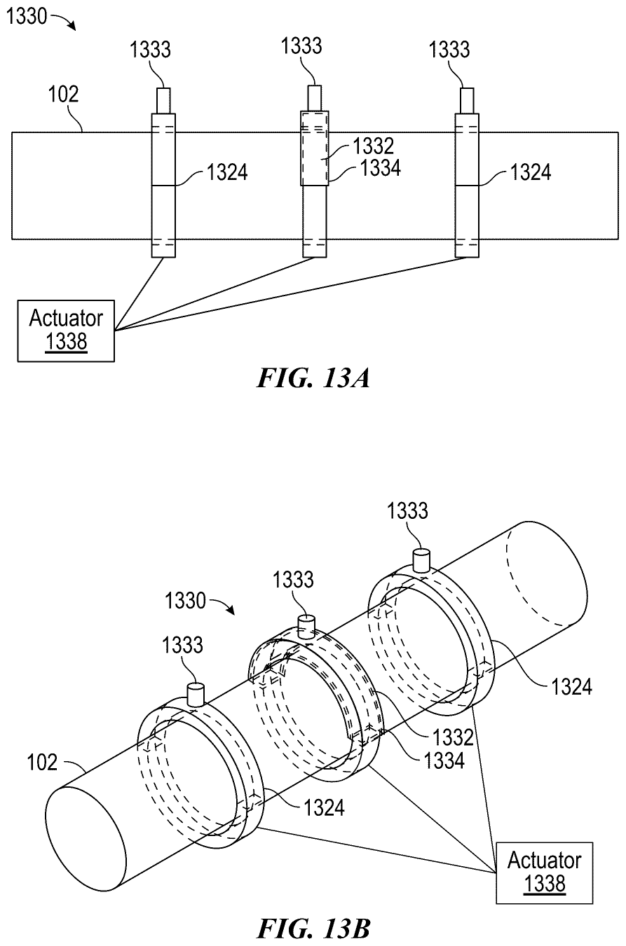

FIGS. 13A and 13B are side and perspective views, respectively, of a WPT unit 1330 with a “triple lock” design in accordance with embodiments of the present technology. The WPT unit 1330 can include an induction coil 1332 electrically connected to a UAV (e.g., the battery of the UAV), a first field guiding portion 1334 disposed proximate to the induction coil 1332, a second field guiding portion 1336 operatively coupled to the first field guiding portion 1334, a UAV interfacing portion 1333 attached to the first field guiding portion 1334, and an actuator 1338 operatively coupled to at least one of the first or second field guiding portions 1334, 1336. The WPT unit 1330 can comprise any suitably configured one (or more) of the WPT unit designs shown and described herein.

The UAV can also carry at least one support member 1324. In some embodiments, the at least one support member 1324 does not include any wireless power transfer components (e.g., an induction coil, a field guiding portion). The at least one support member 1324 can include a wide range of materials such as plastic, wood, metal, etc. In the illustrated embodiment, two support members 1324 are shown positioned on either side of the WPT unit 1330 on powerline 102. Each support member 1324 can have a clamp design, a rotational design, a clamp lock design, a non-straight rail design, a straight rail design, or any other design for gripping onto the powerline 102. In some embodiments, the two support members 1324 can be rotated via an actuator to grip onto the powerline 102, similar to the embodiment shown in and described above with respect to FIGS. 12A-C.

While power is transferring from the powerline 102 to the UAV via the WPT unit 1330, the at least one support member 1324 can grip the powerline 102 and provide stability to the UAV. To cease power transfer from the powerline 102, the at least one support member 1324 can be disengaged from the powerline 102 along with the WPT unit 1330. The WPT units 1330 and the at least one support member 1324 can then move up (e.g., closer to the UAV) for improved aerodynamic performance during flight.

B.10 Ski Design

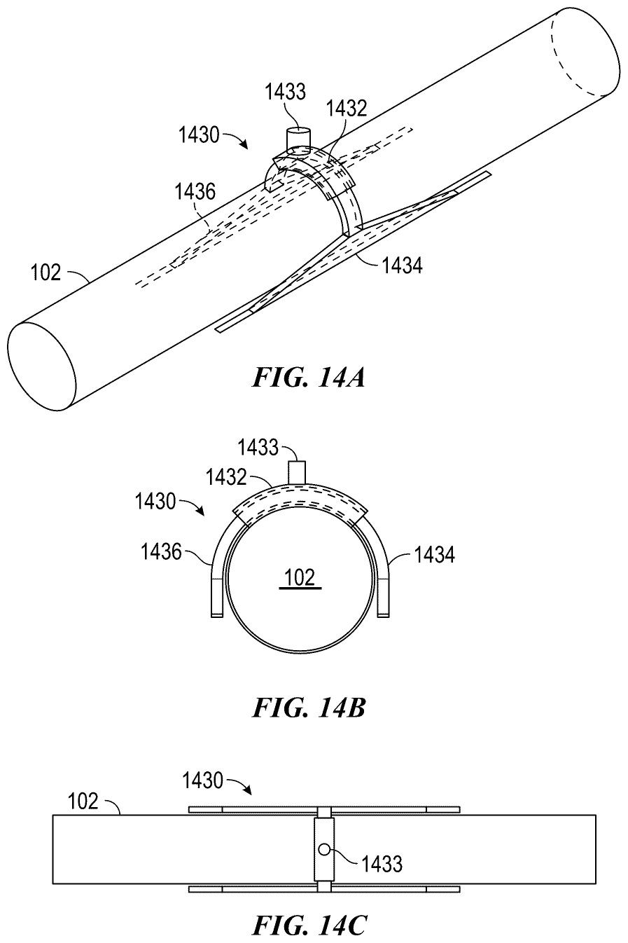

FIGS. 14A-C are perspective, front, and top views, respectively, of a WPT unit 1430 with a “ski” design in accordance with embodiments of the present technology. The WPT unit 1430 can include an induction coil 1432 electrically connected to a UAV (e.g., the battery of the UAV), a first field guiding portion 1434 disposed proximate to the induction coil 1432 and having a first elongate member, a second field guiding portion 1436 attached to the first field guiding portion 1434 and having a second elongate member extending parallel to and spaced apart from the first elongate member, and a UAV interfacing portion 1433 attached to at least one of the first or second field guiding portions 1434, 1436. The first and second field guiding portions 1434, 1436 can be integrally formed or be separate components attached to each other. In the illustrated embodiment, the induction coil is disposed proximate to (e.g., wound around) a junction between the first and second field guiding portions 1434, 1436.

To transfer power from the powerline 102 to the UAV, the WPT unit 1430 can be moved toward the powerline 102 until the first and second field guiding portions 1434, 1436 at least partially encircle powerline 102, and the first and second elongate members extend along a length of the powerline 102. In some embodiments, the WPT unit 1430 can rest atop the powerline 102 as the first and second elongate members provide stability. By extending along the length of the powerline 102, the first and second elongate members can also receive flux from the powerline 102 to a greater degree, and can guide more of the magnetic field generated by the powerline current to the induction coil 1432, compared to other WPT unit designs described herein, providing higher power transfer efficiency. The rate of power transfer can be controlled by changing a distance between the WPT unit 1430 and the powerline 102. In some embodiments, the first and second elongate members can also serve as

To cease power transfer from the powerline 102, the WPT unit 1430 can move up closer to or with the UAV as the UAV continues its flight.

B.11 Roller Design

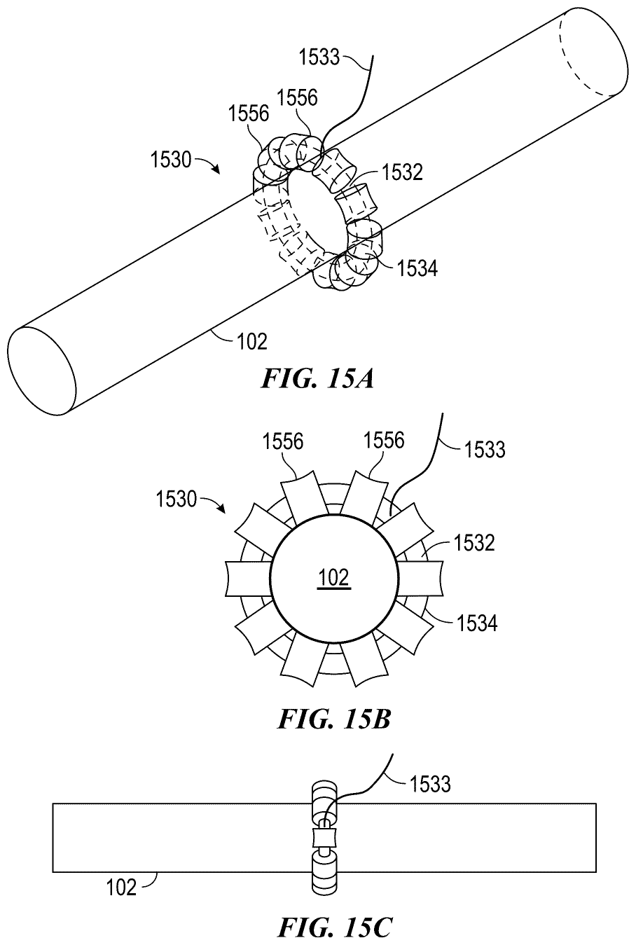

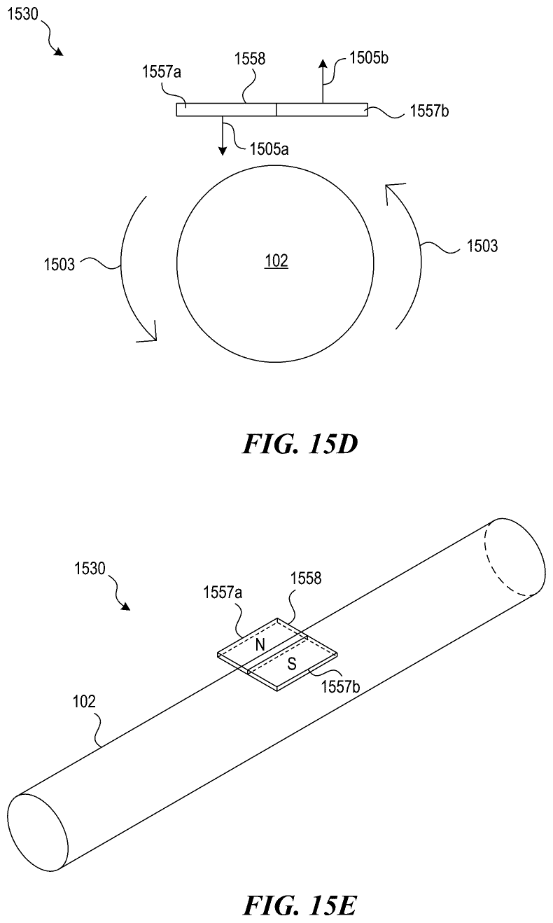

FIGS. 15A-C are perspective, front, and top views, respectively, of a WPT unit 1530 with a “roller” design in accordance with embodiments of the present technology. The WPT unit 1530 can comprise any suitably configured WPT unit designs described herein (e.g., clamp design, rotational design). A UAV carrying the WPT unit 1530 can also carry a plurality of bearing members 1556 (e.g., ball bearings, roller bearings) disposed and positioned to rotate around a field guiding portion 1534 of the WPT unit 1530. In some embodiments, the induction coil (not shown) can be coiled in between individual ones of the bearing members 1556.

To transfer power from the powerline 102 to the UAV, each of the bearing members 1556 can be attached to and/or moved with a portion of the WPT unit 1530 such that the WPT unit 1530 and the bearing members 1556 can engage with or disengage from the powerline 102 together. While power is transferred to the UAV, the UAV may continue to fly from one position to another. As the UAV flies, the UAV can pull on the WPT unit 1530 via interfacing portion 1533 (e.g., a tether) and the bearing members 1556 can roll along a length of the powerline 102, allowing the WPT unit 1530 to smoothly move with the UAV. The WPT unit 1530 and the bearing members 1556 can repeatedly disengage from and engage with the powerline 102 as the UAV moves from one powerline segment to another (e.g., segments separated by utility poles).

B.12 Levitate Plate Design

FIGS. 15D and 15E are front and perspective views, respectively, of a WPT unit 1531 with a levitating design in accordance with embodiments of the present technology. The WPT unit 1531 can include a plate 1558 with a first half 1557a (e.g., illustrated with “N” polarity) and a second half 1557b (e.g., illustrated with “S” polarity). Each of the first and second halves 1557a/b can include a set of wires or windings whose current flow can be controlled. In other words, each half of the plate can correspond to a variable electromagnet. The first and second halves 1557a/b can have opposing polarities with controlled magnitude for the generated magnetic strength/flux.

In some embodiments, the UAV can levitate on or over the powerline 102 by introducing, via the plate 1558, an opposing electromagnetic force (EMF) on the powerline. The alternating current carried by the powerline 102 can generate a magnetic field 1503 about the powerline 102. Given the changes in the alternating current, the magnetic field 1503 can also change polarity. For example, a 50 Hz or a 60 Hz AC signal carried by the powerline 102 can generate the magnetic field 1503 that has a matching frequency with an offset phase (e.g., a reactive delay). Accordingly, the polarity (e.g., the direction of the magnetic field/flux), the magnitude of the magnetic field, or a combination thereof can change in reaction to or according to the AC.

The plate 1558 can be used to generate magnetic fields (e.g., fields 1505a/b) that match the magnetic field 1503 generated by the powerline 102, thereby providing forces that push away from the powerline 102 and lift the connected UAV. Since the AC current follows a predetermined frequency and pattern, the UAV can control the current flowing through the winding in each of the first and second halves 1557a/b. For example, the current flowing through the windings in the plate can be controlled to match the AC frequency of the current flowing through the powerline 102 such that the magnetic field 1505a/b generated by the first and second halves 1557a/b can be used to generate a repelling or a lifting force. In some embodiments, the UAV can move forward or backward along the powerline 102 by controlling an orientation and/or a phase of the fields 1505a/b relative to the magnetic field 1503 generated by the alternating powerline current in the front and the rear of the UAV, thereby generating pulling and pushing forces on the front or rear of the UAV. Moving backward or stopping can be achieved by changing the field phases at the front and rear of the UAV.

In some embodiments, the plate 1558 with adjacent planar halves 1557a/b can be used along with the WPT unit, the propulsion system, or both. In other embodiments, the plate 1558 can be implemented without or in the place of the WPT unit, the propulsion system, or one or more portions thereof.

B.13 Dielectric Design

FIG. 16A is a perspective view of a WPT unit 1630 that can provide capacitive charging to a UAV in accordance with embodiments of the present technology. FIGS. 16B and 16C are front views of the WPT unit 1630 contacting a powerline and separated from the powerline, respectively. The WPT unit 1630 can include a capacitor plate 1652, a UAV interfacing portion 1633 attached to a first side of the capacitor plate 1652, and a dielectric material 1654 disposed adjacent to a second side of the capacitor plate 1652 opposite the first side. In some embodiments, the dielectric material 1654 can comprise a material with high permittivity such as barium titanate (BaTiO₃), tantalum pentoxide (Ta₂O₅), strontium titanate (SrTiO₃), lead zirconate titanate (PZT), polyvinylidene fluoride (PVDF), barium strontium titanate (BST), hafnium oxide (HfO₂), and aluminum oxide (Al₂O₃). In the illustrated embodiment, the capacitor plate 1652 and the dielectric material 1654 form a partial cylinder with a thickness (e.g., radius) of D2.

By bringing the WPT unit 1630 proximate to powerline 102, the WPT unit 1630 can provide capacitive charging to the UAV. The capacitor plate 1652 can be configured to provide a capacitor terminal for capacitively coupling to the powerline 102 across a separation space between the powerline 102 and the capacitor plate 1652. In other words, the capacitor plate 1652 and the powerline 102 on opposite sides of the dielectric material 1654 and/or the airgap can form a capacitor. Accordingly, the alternating current carried by the powerline 102 can cause a capacitive reaction at the capacitor plate 1652.

The rate of power transfer can be controlled by changing a distance D1 between the powerline 102 and the WPT unit 1630. The thickness D2 of the dielectric material 1654 can also be predetermined to control an expected rate of power transfer. The capacitor plate 1652 and the dielectric material 1654 can also shield various components of the UAV from the electromagnetic field generated by the current flowing through the powerline 102. It is appreciated that the WPT unit 1630 can include multiple capacitor plates, and that the capacitive charging design illustrated in FIGS. 16A-C can be combined with any one or more of the inductive charging designs illustrated in FIGS. 5A-15C. For example, the capacitor plate 1652 can be electrically coupled to an induction coil for leveraging both capacitive and inductive electro-magnetic coupling in generating power from the wirelessly coupled powerline.

### C. WPT UNIT SHIELDING

In some embodiments of the present technology, a UAV system can also include a shielding assembly configured to protect the electronics and/or circuitries of the WPT unit and/or UAV components from strong electromagnetic fields at close proximity to the powerline, without or substantially without exceeding any weight limits of the system. The shield assembly can include various components, including those described below.

C.1 Paint or Coating

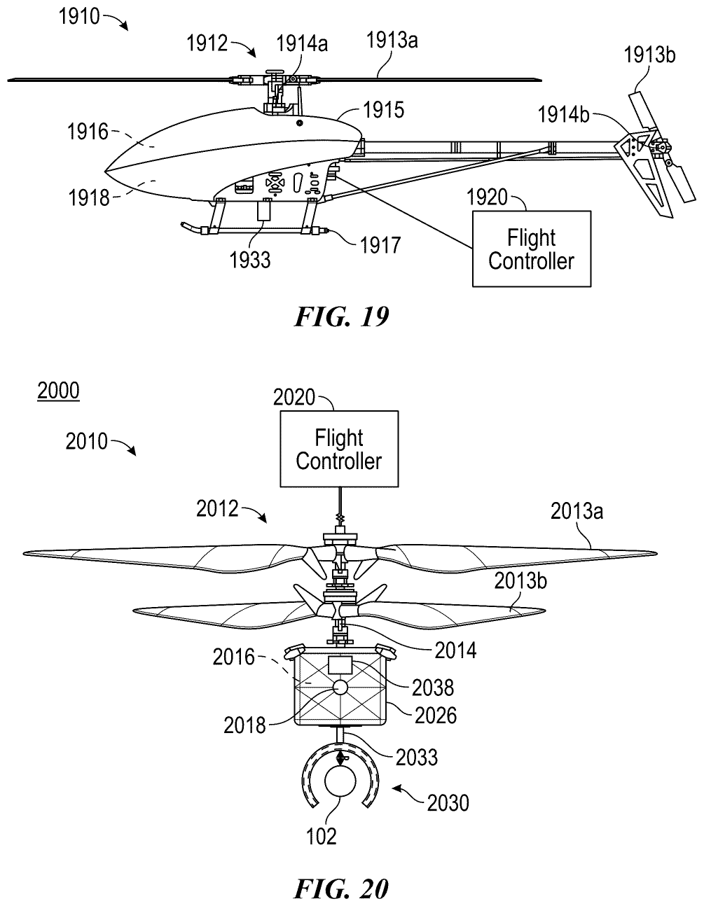

In some embodiments, a protective coating or paint can be applied to shield the electronics from EMI effects and guide the magnetic field around a compartment that houses the electronics. The coating thickness, type, and/or application process can affect the degree of protection provided to components inside the housing, such as the housing described further below with reference to FIGS. 19-21. In some embodiments, the coating can include aluminum foil, nanocrystalline foil, or other conductive and/or ferromagnetic material.

C.2 Magnetic Field Guiding Techniques

In some embodiments, the field guiding portions described above can protect exposed parts of the UAV (e.g., components excluding the WPT unit) and/or internal circuitries from magnetic or electric fields while guiding the remaining fields to the WPT unit, serving a dual-purpose. In some embodiments, the UAV system can include field guiding portions positioned outside of the WPT unit that primarily serve to provide shielding.

### D. WPT UNIT SIZING & MANUFACTURING

Reducing and/or minimizing the overall weight of the WPT unit is a very important consideration in aerial applications. A WPT unit that is too heavy can require larger UAVs that are not practical for certain critical applications. Accordingly, UAVs of the present technology (and/or the components thereof) can include lightweight materials such as carbon fiber or other materials having a low density, structural flexibility, and/or low electrical conductance. Some components that affect the WPT gross weight include the induction coil, the weight of which is a function of the number of coil wire turns, length, thickness, and material properties. Accordingly, the number of coil wire turns and the coil wire's thickness can be selected (e.g., optimized) to reduce (e.g., minimize) the weight of coil wire in the UAV. Using electromagnetic simulation, including eddy current effect, the effect of added AC loss can be estimated for reducing the thickness of the coil and reducing the conductivity for lower weight. In some embodiments, aluminum can be used to significantly reduce weight.

### E. WPT UNIT LOCKING AND UNLOCKING MECHANISMS

In some embodiments, the WPT unit can include an actuator and moving components (e.g., field guiding portions) to engage with or disengage from a powerline, as described above with respect to some of the WPT unit designs. During the power transfer process, it is important that the WPT unit remains on and/or around the powerline. It is also important that the WPT unit can reliably disengage from the powerline after the charging process such that the UAV can continue its mission.

E.1 Mechanical Mechanisms

In some embodiments, the WPT unit can include a flexible and/or low-friction material (e.g., rubber, resin) attached along an inner diameter (ID) of the WPT unit such that during a charging process, the material engages an outer diameter (OD) of a powerline, which can range from 0.1-inch (e.g., for low-voltage powerlines) to 1-inch or more (e.g., for high-voltage powerlines). The WPT unit can be sized larger to accommodate larger powerlines, and the material can be compressed upon the WPT unit engaging the powerline, allowing the WPT unit to grip onto powerlines of varying ODs.

In some embodiments, to reliably disengage the WPT unit from the powerline, the WPT unit can include an actuator (e.g., a lead screw powered by a servo-motor) to move one field guiding portion relative to another (e.g., clamp design, rotational design). In some embodiments, the WPT unit can further include a rail or other pathway on which one field guiding portion can move relative to another (e.g., non-straight and straight rail designs). In some embodiments, a first field guiding portion can first be secured onto the powerline while a second field guiding portion is spaced apart from the first field guiding portion, then the actuator can move the second field guiding portion to also engage the power line (e.g., via rotation, via a rail).

E.2 Electrical Mechanisms

In some embodiments, an electromagnetic force can be generated at an airgap (e.g., in the clamp design, the rotational design) that can be advantageous in keeping the WPT unit secure during charging. However, the electromagnetic force can also make it more difficult to disengage the WPT unit from the powerline. For example, a powerful actuator that is large and heavy may be required to overcome the force, which can be difficult for aerial applications of the present technology.

In some embodiments, the electromagnetic force at an airgap can be temporarily reduced by applying a reverse current in the induction coil such that a magnetic field of the opposite direction of the induced magnetic field is generated. The phase of the reverse current applied in the induction coil may be adjusted to be 180 degrees off from the current flowing in the powerline. One example method of achieving the required reverse current is to generate the reverse current from the induced current by amplifying the induced current by a large negative value. Another example method is to measure or approximate the instantaneous electromagnetic force at the airgap, and generate a reverse current that can cancel the force. In some embodiments, a closed feedback loop can optimize the reverse current in order to fully cancel the electromagnetic force at the airgap.

In some embodiments, the electromagnetic force at the airgap can be reduced by design at the cost of having a reduced beneficial force during the charging process. One example method is to increase the surface area of the WPT unit components (e.g., the field guiding portions). The electromagnetic force at the airgap can be represented as:

$${F}_{AG} ≅ \frac{{B}_{⊥}^{2} A}{2 {μ}_{0}} ∝ \frac{Φ}{2 A {μ}_{0}}$$

where F_{AG} is the electromagnetic force at the airgap, A is the surface area interfacing the airgap, B_{⊥} is the magnetic field density perpendicular to the surface area interfacing the airgap, Φ is the magnetic flux at the field guiding portions within a threshold distance from the airgap, and μ₀ is the vacuum permeability constant. The UAV (via, e.g., one or more processors) can use the above-described relationship based on assuming a uniform magnetic field (i.e., B_{⊥}=Φ/A) and while the ferromagnetic material (e.g., the field guiding portion) is operating in a high permeability (linear) region.

In some embodiments, the ends of the field guiding portions can be flared at the manufacturing stage to have a greater surface area at the airgap, as shown in FIGS. 6A-C. In some embodiments, an actuator can increase the effective surface area at the airgap during the charging process by, for example, opening a fan-shaped ferromagnetic component positioned at the ends of the field guiding portions.

### F. WPT UNIT ELECTRICAL CIRCUITS

F.1 Inductive/Capacitive Power Transfer Circuit

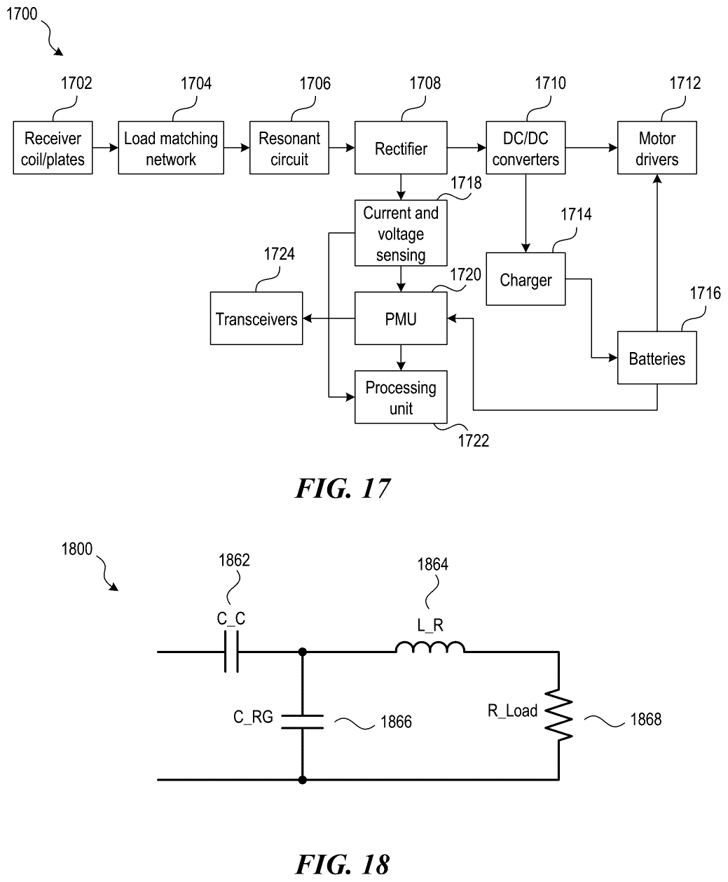

FIG. 17 is a schematic of a power transfer system 1700 (“system 1700”) in accordance with embodiments of the present technology. The system 1700 includes an induction coil and/or a capacitive plate 1702 (“receiver”) that can generate power from wirelessly or electromagnetically coupling to a powerline, as described above with respect to the various WPT unit designs. The receiver can be connected to a load matching circuit or network 1704 that balances out the overall impedance of the power transfer circuit, as load imbalance can cause additional resistance and inefficiency. The load matching network 1704 can include highly coupled inductances and/or highly coupled capacitances that can match the quality factor and impedance of the receiver to load. A resonant circuit 1706 can reduce the impedance of the receiver and/or increase the receiver's power delivery efficiency, as will be described in further detail below with respect to FIG. 18. A rectifier circuit 1708 can change an alternating current (AC) input from the resonant circuit 1706 to a direct current (DC) output voltage. The rectifier circuit 1709 can include passive elements (e.g., diodes) or active/dynamic elements (e.g., controlled n-type channel metal oxide semiconductor (nMOS) and/or p-type channel metal oxide semiconductor (pMOS) transistors) that are chorographically controlled, which can improve the efficiency of the rectifier circuit 1708. The output of the rectifier circuit 1708 can be directed to a sensory path and a powering path.

In the powering path, the DC output of the rectifier circuit 1708 can be further regulated or adjusted through a DC-to-DC converter 1710. For example, the DC/DC converter can leverage or reduce current in order to push the voltage higher (e.g., step up), or vice versa. In some embodiments, the DC-to-DC converter 1710 can also be configured to distribute power between motor drivers 1712 and batteries 1716 (e.g., the batteries 116) of the UAV. For example, the DC-to-DC converter 1710 can prioritize one over the other depending on sensor measurements, mission criteria, etc. The motor drivers 1712 can drive motors included in a propulsion system (e.g., the propulsion system 112) or actuators (e.g., the actuator 138) included in the UAV. The charger 1714 can condition the input voltage to match requirements of the batteries 1716.

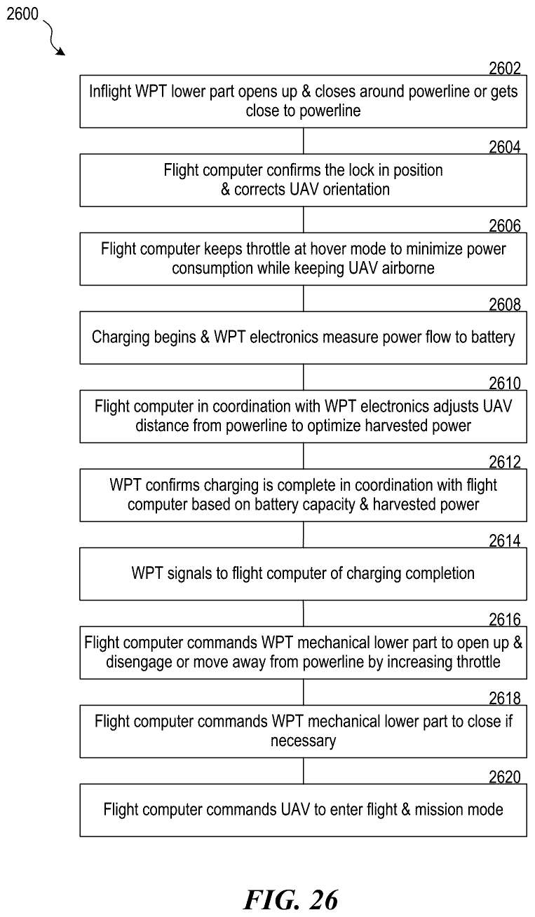

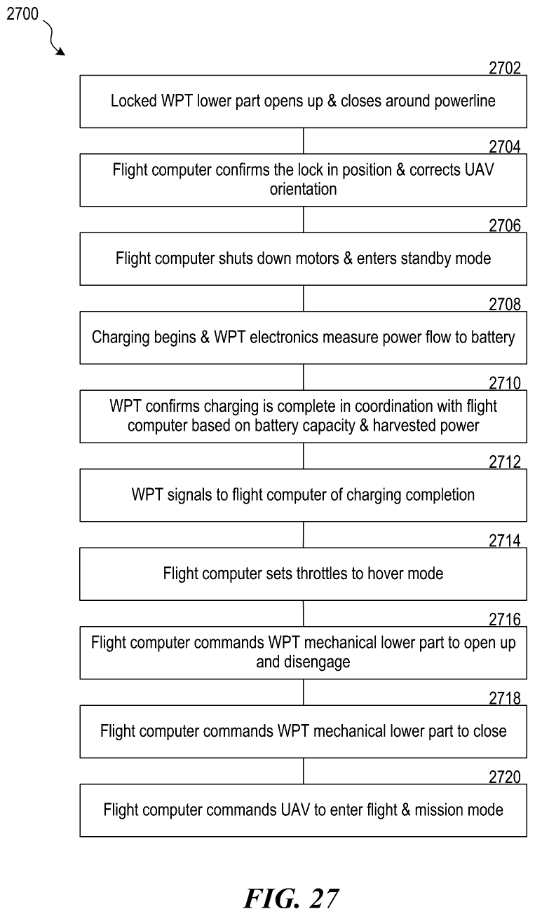

In the sensory path, a current-and-voltage sensing circuit 1718 can include components to measure the current and/or voltage passing to the powering path. A power management unit (PMU) 1720 can, in conjunction with a processing unit 1722 in some embodiments, determine how to adjust the rate of power transfer (e.g., by adjusting the distance between the WPT unit and the powerline, by adjusting airgaps). The processing unit 1722 can include a CPU and/or logic unit with instructions. In some embodiments, the current-and-voltage sensing circuit 1718, the PMU 1720, and the processing unit 1722 can form a feedback loop that can iteratively optimize the rate of power transfer. If the rate of power transfer is lower than a desired rate and controlling an actuator (e.g., the actuator 138) included in the WPT unit may not sufficiently raise the rate of power transfer to a required level, a flight controller can switch from an in-flight wireless charging mode to a stationary wireless charging mode, as will be described in further detail below with respect to FIGS. 26 and 27. If the batteries 1716 are charged above a predetermined threshold, the UAV can fly away from the powerline to continue its mission (e.g., aerial inspection), then return to the powerline for continuing the charge after performing its tasks.

In some embodiments, one or more components in the sensory path can determine one or more harmonic components within the generated power, measure an amount of the generated power, and/or estimate a current carried by the powerline according to the one or more harmonic components and the amount of the generated power. In the case of non-linear ferrous materials (e.g., making up the field guiding portions), it can be important to check whether the material is operating in a linear (high permeability) region and thus adhering to known principles of harmonics and heating. When there is excessive flux passing through a non-linear ferromagnetic material, the material can enter a saturation region in which (i) most of the energy of the magnetic field is converted into heat and (ii) the ferromagnetic material loses its beneficial properties and exhibits properties similar to a vacuum. To check whether the field guiding portion material has started to saturate, the ratio of harmonics to the fundamental frequency in the received current can be checked. If the harmonics ratio has increased above a certain threshold (e.g., 6%, 8%, 10%), it may indicate that the material has saturated and is operating in a non-linear region. The PMU 1720, the processing unit 1722, or a combination thereof can use a predetermined method (e.g., a Fourier Transform and subsequent frequency-based analysis) to find targeted harmonics, such as predetermined harmonics of the AC current carried by the powerline. The 1720, the processing unit 1722, or a combination thereof can further derive the harmonics ratio α from the induced, non-rectified current in the induction coil as follows:

$$a = \sqrt{{\sum }_{n = 2}^{m} \frac{{I}_{n}^{2}}{{I}_{1}}}$$

where Iₙ is the n^{th} harmonics of the powerline AC frequency.

In some embodiments, when the UAV determines that the a field guiding portion is saturated and the ferrous material for the field guide is operating in a non-linear region (or a linear region), the UAV can adjust (1) an airgap between the WPT unit and the powerline, (2) an orientation of the WPT unit relative to the powerline, or both for maintaining a targeted state of the wireless coupling between the WPT unit and the powerline. For example, the UAV can adjust the position of the WPT unit relative to the powerline to maintain the ferrous material operating in the linear region.

When the ferrous material is operating in the linear region (e.g., when the power distribution in the harmonic components is below the threshold), the sensory path can use measurements relating to the airgap and the transferred power to calculate or estimate the current flowing in the powerline. Since the ferrous material is operating in the linear region, the relationship between the received/generated power and the current carried by the powerline can be modeled using a predetermined method. In some embodiments, the sensory path can measure or estimate the current flowing through the powerline based on the power that is transferred to the UAV and specific characteristics of the WPT unit. For example, the UAV can use the measured airgap and the generated power (e.g., according to a predetermined formula) to estimate the magnitude of the current flowing in the powerline. The measured or estimated powerline current can be used to create a real-time current distribution map (e.g., a digital twin of the utility infrastructure, as discussed below under Section I.1). The powerline current can also be used to detect any off-metered power tapping in rural areas or other areas. In some embodiments, the powerline current can be calculated as:

$${I}_{line} = \frac{{I}_{rx}}{k ( a )}$$

wherein k(α) is a coupling coefficient defined as a function of the harmonics ratio α defined above.

One or more transceivers 1724 can communicate the data measured or determinations made by the system 1700 to components external to the system 1700 (e.g., a remote server). The transceivers 1724 can also receive instructions (e.g., missing, specific maneuvers, or other operating instructions) from an external device. In some embodiments, the PMU 1720 and the processing unit 1722 can form a power management integrated circuit (PMIC) that receives a stable (or clean) source of power from the batteries 1716, which can then be transmitted to sensitive electronic components such as processors, sensors (e.g., cameras), navigation components, the transceivers 1724, etc.

F.2 Resonant Circuit

FIG. 18 is a schematic of a resonant circuit 1800 in accordance with embodiments of the present technology. In some embodiments, the resonant circuit 1800 can be an example of the resonant circuit 1706 shown in and described above with respect to FIG. 17. Capacitive power transfer (CPT) systems can enhance the wireless charging efficiencies from either the receiver side or transmitter side of the system. Since there is no access to the transmitter side (e.g., high voltage transmission cables) in many applications, embodiments of the present technology can apply capacitive power transfer techniques to the receiver side to partially improve the efficiency of wireless power transfer. One technique is introducing the resonant inductance 1864 to reduce the receiver's electrical impedance at the frequency of operation (50-60 Hz) and maximize the deliverable power. Another technique is to introduce a matching circuit to flatten the efficiency curve and make it more practical for circuit variations which results in variation in optimum frequency of operation (which usually determines the resonance frequency). Such variations can be introduced into the present technology by misalignment and varying the distance of the UAV to the transmission cables.

As illustrated in FIG. 18, the inductance L_{R} 1864 is added to reduce the impedance of the receiver and deliver most of the power to an equivalent load resistance of R_{Load} 1868 and a matching capacitance of C_{RG} 1866 is added to reduce the inductance value (given the ultra-low frequency of operation) and flatten the efficiency curve of the CPT system, allowing more variations in the coupling capacitance value of capacitor C_{c} 1862 at the cost of lowered peak efficiency.

The resonant circuit 1800 can significantly increase the power delivery efficiency of a receiver (e.g., an induction coil, a capacitor plate). The power delivery efficiency can be optimized (e.g., maximized) if it coincides with the resonance frequency as calculated below:

$${f}_{o} = \frac{1}{2 π \sqrt{{L}_{R} {C}_{C}}}$$

where fₒ is the resonance frequency, and L_{R} and C_{c} are the value of the resonant inductor and capacitor, respectively. For applications in which the transmitter comprises 50-60 Hz transmission or distribution powerlines, the resonance frequency is equal to the line frequency. Accordingly, the size and weight of the inductor 1864 and the capacitor Cc 1862 can be challenging to adjust given the maximum-take-off-weight requirements of UAVs.

Embodiments of the present technology can solve this problem. For example, embodiments of the present technology include inductive and capacitive coupling techniques that use the coupling capacitance between a capacitor plate and a powerline, and the inductance of an induction coil as an L_{R}*C_{C} resonator. One or both of the inductance and capacitance values can be varied as needed. In these and other embodiments, the efficiency of the power transfer can also be based on the capacitive coupling the capacitor plate and the powerline, which can be controlled by changing the distance therebetween. This efficiency control method can enable finer adjustment of the transferred power.

In some embodiments, the WPT unit can be current-dependent (e.g., rather than voltage-dependent) such that the WPT unit can work with many types of KV line types carrying different currents.

### G. UAV DESIGN

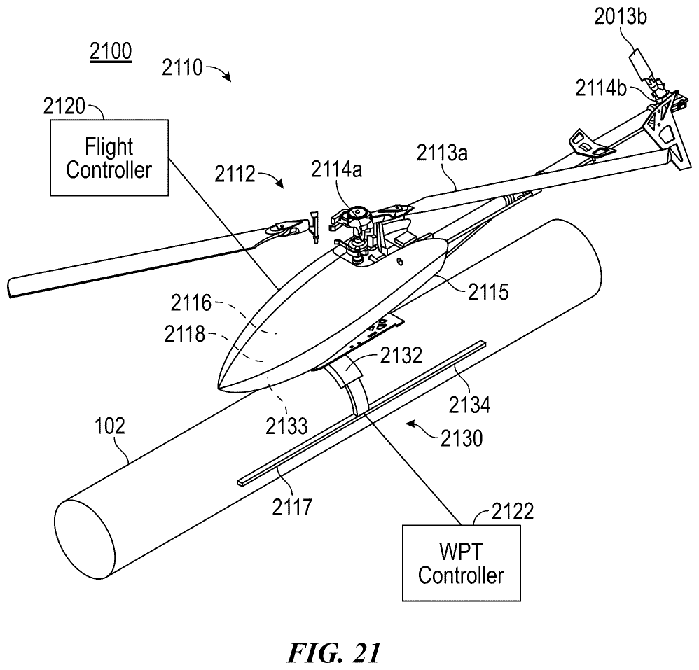

One or more of the WPT units described herein can be carried by UAVs having single rotor designs (e.g., shown in FIGS. 19 and 21) and/or double rotor designs such as a coaxial rotor arrangement (e.g., shown in FIG. 20). Both single and double rotor designs are expected to have high flight efficiency and performance, such as in unfavorable flight conditions (e.g., in high gust and/or windy conditions). In addition, the UAVs can be custom designed per mission requirements, be rugged, be water resistant, and/or include industrial grade material, increasing operability profile and/or duty lifecycle.

The WPT designs described herein can be sized, designed, and/or deployed for various critical missions and serve any of a variety of different purposes (e.g., powerline inspection, fire prevention, delivery, border surveillance, etc.). The present technology can power miniature UAVs (e.g., less than about 250 g/0.55 lbs; classified as micro air vehicles (MAVs) or nano air vehicles (NAVs)), small UAVs (e.g., 1 lb), large UAVs (e.g., 20 lbs or more), and those in between, providing flexibility in accommodating many use-case scenarios. The WPT units of the present technology can operate on powerlines in both urban and rural areas.

G.1. Helicopter Design

FIG. 19 is a side view of a UAV 1910 with a helicopter design in accordance with embodiments of the present technology. The UAV 1910 can include a housing 1915, a propulsion system 1912 attached to the housing 1915, batteries 1916 stored inside the housing 1915, sensors 1918 (e.g., cameras) secured to the inside or outside of the housing 1915, landing skids 1917 attached to the housing 1915, and an interfacing portion 1933 attached to the housing 1915. A flight controller 1920 can be included onboard and/or located at a remote location to communicate with the UAV via a network and/or a local connection. The propulsion system 1912 can include a main rotor 1913a, a main motor 1914a configured to rotate the main rotor 1913a, a tail rotor 1913b, and a tail motor 1914b configured to rotate the tail rotor 1913b.

The illustrated single main rotor helicopter design is an efficient platform, both from an aerodynamics perspective and a performance perspective, and is expected to withstand high gust conditions and integrate well with the WPT units described herein, which can be connected to the UAV 1910 via the interfacing portion 1933 in some embodiments. The illustrated UAV 1910 can be designed to weigh less than 250 g while carrying all the main components (e.g., WPT electronics, flight computer, battery, motors, structure, sensors, etc.). The WPT system can be customized to generate power to charge the helicopter battery, and may be implemented on, in, or with the landing skids 1917, e.g., so the WPT unit can support the UAV 1910 when not in-flight.

G.2. Coaxial Rotor Design

FIG. 20 is a side view of a UAV 2010 with a coaxial rotor arrangement in accordance with embodiments of the present technology. The UAV 2010 can include a propulsion system 2012 and can carry an enclosure 2026 (e.g., a box with an underside door or opening) attached to the propulsion system 2012. A flight controller 2020 (e.g., the flight controller 120) can be carried by the UAV 2010 (e.g., stored inside the enclosure 2026), and/or can be located off-board the UAV 2010. Batteries 2016 can be stored inside the enclosure 2026, one or more sensors 2018 can be secured on the exterior of the enclosure 2026 (e.g., on each face of the illustrated enclosure box), and a WPT unit 2030 can be extended and/or retracted from the enclosure 2026 via an interfacing portion 2033 and an actuator 2038. The WPT unit 2030 can comprise any one or more of the WPT unit designs described above. The propulsion system 2012 can include a first rotor 2013a, a second rotor 2013b stacked below the first rotor 2013a, and one or more motors 2014 positioned to control the first and/or second rotors 2013a/b. In some embodiments, the first and second rotors 2013a/b can be housed in a protective structure (e.g., a box, a pipe) to prevent contact with powerlines. As described in detail above under Section C, to protect the various components from the strong electromagnetic fields near powerlines, the enclosure 2026, the WPT unit 2030, and/or the UAV 2010 include a shielding assembly.

In some embodiments, the first and second rotors 2013a/b can be configured to rotate in opposite directions (e.g., clockwise and counter-clockwise, respectively). This design is expected to withstand high gust conditions and is high performance in nature, allowing a high degree of maneuverability. The rotors of this platform operate in low Reynolds number in a laminar flow regime that reduces the drag and increases the energy efficiency of the craft.

To transfer power from a powerline 102 to the batteries 2016 of the UAV 2010, the actuator 2038 can extend the WPT unit 2030 outside of the enclosure 2026 and toward the powerline 102. In some embodiments, only a portion of the WPT unit 2030 (e.g., a second field guiding portion) may extend outside of the enclosure 2026. After the power transfer is complete, the actuator 2038 can retract the WPT unit 2030 back into the enclosure 2026 to improve the aerodynamic efficiency of the UAV 2010. Retracting the WPT unit 2030 can also reduce undesirable swinging motions of the UAV 2010 by bringing the centers of gravity of the propulsion system 2012 and the WPT unit 2030 closer together (i.e., increasing the static and dynamic stability of the UAV 2010 by reducing the momentum of inertia).

Maintaining appropriate operating conditions (e.g., temperature, humidity) for the various components of the UAV can be important during operation. In some embodiments, downdraft from the first and second rotors 2013a/b can provide cooling to the enclosure 2026. In some embodiments, the UAV 2010 can carry an HVAC system (e.g., a phase-change cooler, a resistive heater, etc.) inside the enclosure 2026 or at a different position.

G.3. UAV and WPT Unit Integration

FIG. 21 is a perspective view of a UAV system 2100 (“system 2100”) configured in accordance with embodiments of the present technology. The system 2100 can include a UAV 2110 and a WPT unit 2130 attached to the UAV 2110. In the illustrated embodiment, the UAV 2110 can be generally similar to the UAV 1910 (FIG. 19) having a helicopter design, and the WPT unit 2130 can be generally similar to the WPT unit 1430 (FIG. 14) having a ski design. The WPT unit 2130 can be integrated and/or combined with the UAV 2110 such that the WPT unit 2130 serves as a power transferring device as well as the landing skids 2117, as shown. In some embodiments, the WPT unit 2130 can be attached to the UAV 2110 as a separate component.

G.4. UAV Weight and WPT Unit Power Matching Challenges

The WPT units are configured to generate enough energy to charge the UAV in the inflight or locked design arrangements as well as to allow the UAV to lift the maximum take off weight. Due to the weight by the WPT system to any UAV platform, the system architecture is configured to compensate for the increased weight, for example, by adjusting one or more onboard sub-systems to reduce the weight and/or replace off-the-shelve components with custom and/or miniature sized counterparts.

In larger platforms, weight and/or size limitations may be lessened, allowing for increased flexibility. For example, larger WPTs produce increased power, which in turn translates into being able to use larger-sized UAVs.

### H. NAVIGATION AND CONTROL

UAVs configured in accordance with the present technology can use various sensors (e.g., the sensors 118 identified in FIG. 1) for BVLOS and/or autonomous operation. Additionally, because UAVs of the present technology can operate at or near strong electromagnetic fields, the navigation and control sensors are configured to be resistant or generally resistant to electromagnetic interference. A UAV configured in accordance with embodiments of the present technology can include one or more of the following sensors to assist in, for example, navigation and control.

H.1 Optical Sensor

Cameras or other optical sensors, including optical sensors for use with computer vision (CV) technology, can be configured to detect and identify objects, e.g., to navigate the UAV and/or detect anomalies during missions (e.g., monitoring and inspection of powerlines, etc.).

H.2 Infrared Sensor

Infrared sensors can be used during night operations where there is limited light for optical sensor to operate. They can be a backup system and/or configured for detection of anomalies that can be identified primarily by infrared sensors.

H.3 Hyperspectral Sensor

Hyperspectral sensors can collect and process information from across the electromagnetic spectrum and can detect wavelengths that are not visible to the human eye. They can have various use cases in the UAV platform, such as detection of voltage leakage in utility infrastructure.

H.4 LIDAR Sensor

Light detection and ranging (“LIDAR”) sensors can be used for navigation in the absence of light or under dark mode conditions and can also capture/generate a point cloud for geometry generation, measurement, object detection, navigation, etc., allowing for the creation of 3D models of the environment.

H.5 Electric Field Sensor

Electric field sensors can be used to detect the electric field of a powerline and/or support the navigation and/or control of the UAV over the powerline, e.g., for landing and/or docking with powerlines to charge.

H.6. Sonar Sensor

Sonar sensors can be used for transmitting and receiving ultrasonic waves, and can be implemented on the UAV to achieve autonomous obstacle avoidance in six directions (forward, backward, left, right, up and down) with a low latency.

H.7 RF Sensor

Radiofrequency sensors can be used for transmitting and receiving radio signals, and can be implemented on the UAV for obstacle detection and avoidance purposes.

H.8 Corona Effect Sensor

Specialized visible UV-imaging sensors can be used to measure the corona effect or the partial discharge that occurs when a high voltage causes a localized breakdown of the air around a conductor.

H.9 Edge-Computing

Any of the sensors described herein can produce large amounts of data that can be processed on the UAV platform, such as via an edge computer. For example, the UAV platform can include a graphic processing unit (GPU) and/or a central processing unit (CPU) that analyzes the input data onboard the UAV and makes navigation and control decisions according to the data collected and analyzed. Another output of this system is that select portions of the collected/analyzed data (e.g., overheating spots on a grid, cracks on an insulator, vegetation, or any other issues) are stored on onboard memory and other data can be deleted to save memory space. The stored data can be transferred to a cloud computer when there is an internet connection during mission, e.g., for further processing and/or reporting purposes.

H.10 AI & ML Technologies

In some embodiments, AI and ML technologies are used onboard the UAV computer and/or in back-end computing systems (e.g., cloud computing). The onboard AI and ML algorithms can be configured to sift through the data coming through sensors, analyze, and make navigation, detection, and storing decisions. The AI and ML algorithms on the back-end/cloud computing infrastructure can be used to examine the data collected from all the UAV platforms in flight operation and other industrial internet of things (HOT) sensors and analyze the data in real-time.

H.11 Swarm Deployment

In some embodiments, inspection UAVs can be deployed as swarms to inspect selected assets. The swarm of UAVs can be controlled by a central ground command unit and the UAVs can fly autonomously day and/or night, to inspect grids having a variety of sizes, reduce inspection and/or operating costs, reduce inspection time, and/or improve operator safety. In contrast, for example, with conventional technologies, it is not feasible to fly with UAVs for 30 to 40 minutes and return to base for battery changing then move the ground crew to another location to continue the inspection. Additionally, some areas are hard to reach by ground crew and flying is the only option. Another conventional inspection method is to use helicopters, which is very expensive (e.g., $3000/hr, or $20,000 to $30,000/day, depending on the aircraft size and sensor capabilities), and can additionally place human life in danger.

### I. DATA COLLECTION, PROCESSING & SECURITY

I.1 Real-Time Digital Twin

As the world is moving toward the digitization of real assets (a.k.a. digital transformation), there is a growing need to find ways to enable the data capture and analysis. UAVs are one of the main tools enabling this goal. In some embodiments, data gathered by the UAVs of the present technology can be stored (e.g., on-premises, off-premises, on cloud servers, etc.) and used to build a digital twin of the assets. ML algorithms can analyze the collected data for information and refresh or update the real-time digital twin of the assets. In some embodiments, the real-time digital twin can be integrated with augmented reality (AR) and virtual reality (VR) so that inspectors and technicians can assess and verify the issues, e.g., before taking any maintenance action. The real-time digital twin is expected to facilitate better control and decision-making associated with operation of the UAVs.

I.2 Data Transfer & Infusion

In some embodiments, UAVs configured in accordance with the present technology are equipped with data transmitters configured to transfer and/or offload data to cloud, via, e.g., internet and/or satellite (“SATCOM”). The availability of network might be limited in rural areas, however, there are spots along the grid that UAVs can connect and transfer data. This can also take place during a charging phase. Other communications networks, e.g., Starlink, 5G networks, Bluetooth, etc., can also be used in addition to or in lieu of WiFi and/or SATCOM connectivity.

In some locations, IIOT sensors are being added to the grid. Accordingly, in some embodiments the UAVs can be configured to communicate with such sensors and used as a platform to relay information to a central database where data from different sources can be collected and analyzed to improve prediction and detection models of ML algorithms.

I.3 Data Encryption

In some embodiments, the data collected, processed, and/or stored onboard the UAV can be encrypted in case of an emergency and/or loss of the UAV, and when there is no communication link to transfer the data to the cloud. Data encryption can be important given the sensitive nature of the data and the stakeholders, including owners of electrical utility assets, railway assets, highway assets, etc. The data management plan onboard the UAV can be National Defense Authorization Act (NDAA) compliant. The cloud computing services used for data storage and processing (e.g., Amazon AWS, Microsoft Azure) can also be NDAA certified.

### J. BVLOS OPERATION

J.1 Long Distance Communications

Given the effectively unlimited flight range of UAVs in accordance with embodiments of the present technology, and the fact that most of the missions will be executed Beyond Visual Line of Sight (BVLOS) and in the absence of a Visual Observer (VO), there is a need for multiple communication links between a base station (where multiple UAVs are monitored and controlled) and individual ones of the UAVs. The communication channels can be established via radio, LTE, 5G, SATCOM, etc. for long-range missions. At remote locations where a communication link cannot be established, the UAV can execute the mission using autonomous flight navigation using AI and Computer Vision (CV) technology onboard the UAV until one of the communication links can be established where available.

In some cases, powerline infrastructure is equipped with (or currently being upgraded to be equipped with) broadband internet cables that can be utilized by UAVs for communication and data transfer purposes in the areas with poor internet connectivity. In some embodiments, the UAVs can use the powerline itself for data communication and transfer. While the data transfer rate through powerlines can be slow, it can be used for critical data transfer purposes or in emergency situations (e.g., when the UAV is lost) while, for example, the UAV is resting on the powerline and charging.

J.2 UAV-to-UAV Communications

Local communication can be established between UAVs (e.g., via Bluetooth, Bluetooth Low-Energy) at close proximity to each other. The local communication can be used for handshake or hand-off purposes between UAVs working in the same electrical utility coverage area.

J.3 Service Area and Data Sharing

In some embodiments, a group of UAVs can be controlled in a swarm deployment arrangement, where each UAV covers a certain powerline range or coverage area shared with other UAVs. The data captured (e.g., images, current and voltage readings) can be labeled, geo-tagged, and/or time-stamped so that the data can be shared in a central database accessible by multiple UAVs.

The data gathered over time can provide valuable insight into the changes and risks associated with the assets (e.g., growing tree branches, deteriorating pole structures, vegetation conditions around assets, potential fire hazards, etc.).

### K. RISKS AND MITIGATION PLAN

Given the complex operational environment of UAVs and ability to fly BVLOS autonomously and the inherent risk with such operation, the present technology includes specific design considerations to identify and mitigate the risks. Some of the main risk factors and mitigation plans are listed below.

K.1 Wind & Gust Conditions

One of the benefits of using miniature UAVs is their tolerance for high wind and gust conditions due to their small form factor. The UAVs of the present technology are configured to operate in a wide range of environmental factors (e.g., temperature, wind speed, atmospheric conditions such as rain and snow, etc.).

K.2 Collision and Impact Damage

The UAVs of the present technology can be lightweight (e.g., less than 250 g/0.55 lbs) so that they have minimal impact on the asset (e.g., powerline) in case of collision and impact. Although the onboard CV, AI, ML technology is designed to operate the UAV with minimal error, in the case of emergency the lightweight design of the UAVs can minimize or prevent any damage to the assets and/or other objects during collisions/impacts.

K.3 Electric Shorting

In some embodiments, the UAVs are shielded (e.g., using non-ferrous material) from electric shock and/or shorting, to inhibit or prevent arcing and/or fires. The shielding can include any of the materials and/or shielding assemblies described herein. Furthermore, the small size of the UAVs inhibits or prevents electric shorting that can take place if the UAV acts as the bridge between two powerlines, while getting close enough to the wires to charge the batteries since the size (e.g., wingspan or blade span) of the UAV can be less than the distance between powerlines.

### L. FLOWCHARTS

L.1 Systems

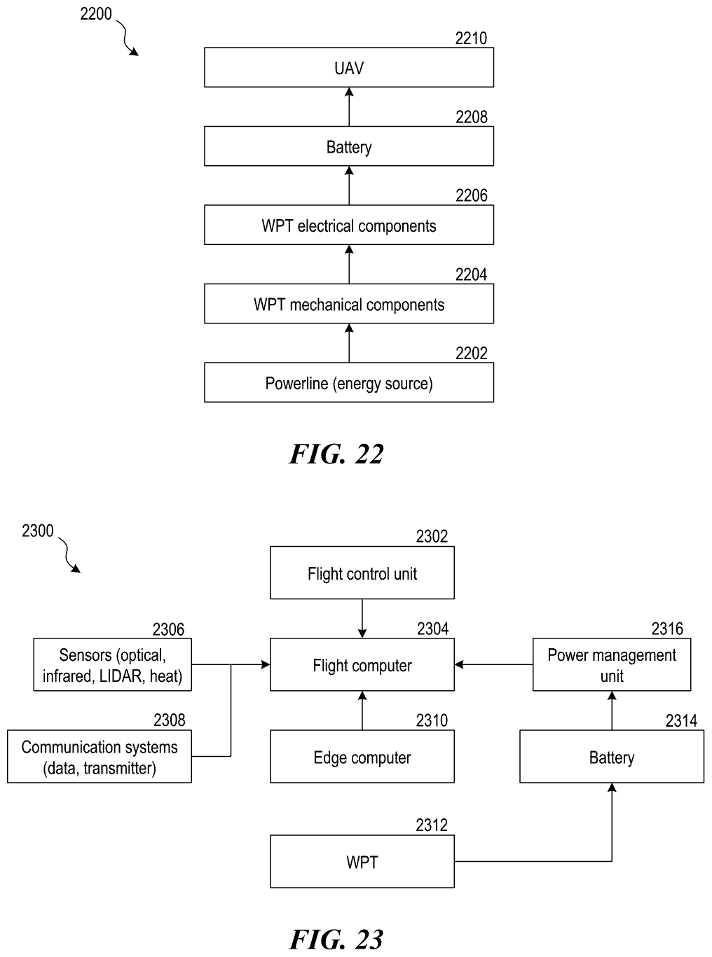

FIG. 22 is a flowchart 2200 illustrating power transfer from a powerline to a UAV in accordance with embodiments of the present technology. At block 2202, a powerline or other energy source has current running through it, which generates an electromagnetic field. At block 2204, mechanical components of a WPT unit (e.g., field guiding portions) can engage the powerline. At block 2206, electrical components of a WPT unit (e.g., induction coil, capacitor plate) can enter the electromagnetic field around the powerline, which can induce current in the electrical components. At block 2208, the induced current can charge a battery of the UAV. At block 2210, the battery can power various components of the UAV, such as a propulsion system, sensors, actuators, etc.

FIG. 23 is a schematic 2300 illustrating subsystems of a UAV in accordance with embodiments of the present technology. A flight computer 2304 can be operatively coupled to and receive various data signals and/or instructions from a flight control unit 2302, sensors 2306 (see, e.g., Section G above), communication systems (e.g., data transmitters), an edge computer 2310, and a power management unit (PMU) 2316. The flight computer 2304 can include logic and/or processor(s) configured to analyze the current context (e.g., sensor readings) and generate corresponding control signals. The flight computer 2304 can further receive inputs from the edge computer 2310.

A battery 2314 can power the PMU 2316, and a WPT unit 2312 can charge the battery 2314 as described herein. The flight computer 2304 can send signals to control operation of the UAV, such as through the flight control unit 2302 and/or the WPT unit 2312. Accordingly, the flight computer 2304 can implement the charging operation to replenish the energy stored in the battery 2314 through the WPT unit 2312 as described above. The flight computer 2304 can further use the WPT unit 2312 and/or the power management unit 2316 to measure/estimate the current carried by the powerline as described above. The flight computer 2304 can send the current measurement data through the communication systems 2308.

L.2 Operation Sequence

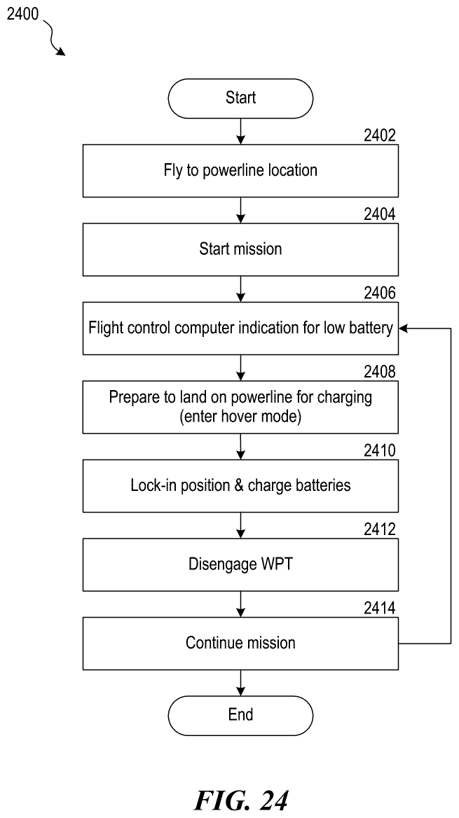

FIG. 24 is a flowchart illustrating a method 2400 of transferring power from a powerline to a UAV in accordance with embodiments of the present technology. At block 2402, the UAV can fly to a location or area around a powerline. At block 2404, the UAV can begin a mission, such as inspecting/monitoring one or more powerlines to collect data and/or detect anomalies. At block 2406, a flight control computer can provide an indication of low-battery to the UAV (or UAV operator). At block 2408, the UAV can prepare to land on a nearby powerline for charging (e.g., by entering hover mode). At block 2410, the UAV can lock-in its position on the powerline, such as by using a WPT unit or support members as described above and charge its batteries by transferring power from the powerline. At block 2412, the UAV can disengage the WPT unit. At block 2414, the UAV can continue its mission until the UAV receives a low battery indication again (block 2406). In some embodiments, the UAV can continue the mission while charging via the powerline.

L.3 Landing Process

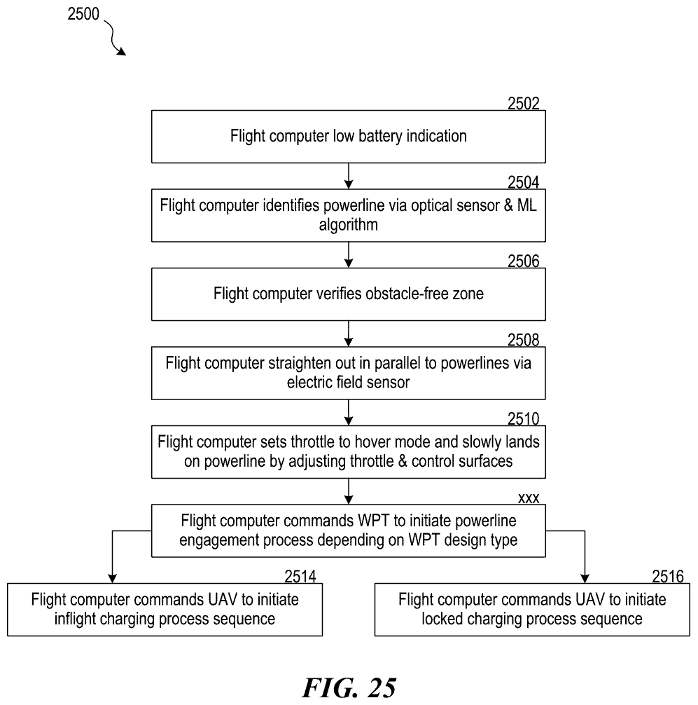

FIG. 25 is a flowchart illustrating a method 2500 of landing a UAV on a powerline in accordance with embodiments of the present technology. In some embodiments, the method 2500 can be performed by the PMIC illustrated in FIG. 17 or the flight computer 2304 illustrated in FIG. 23. At block 2502, a flight computer can provide a low-battery indication to the UAV (or UAV operator). At block 2504, the flight computer can identify a powerline suitable for charging via one or more sensors (e.g., an optical sensor) and/or machine learning (ML) algorithms. At block 2506, the flight computer can verify an obstacle-free zone around the identified powerline. At block 2508, the flight computer can position the UAV to be parallel to the powerline(s) using the one or more sensors (e.g., an electric field sensor). At block 2510, the flight computer can set the throttle or propulsion system to enter a hover mode such that the UAV slowly lands on the identified powerline by adjusting the throttle and control surfaces. At block 2512, the flight computer can command a WPT unit (e.g., actuators in the WPT unit) to engage the powerline, depending on the specific WPT unit design as described above. Afterward, the flight computer can either command the UAV to initiate an in-flight charging process sequence (block 2514) or a locked charging process sequence (block 2516).

L.4 Inflight Charging Process

FIG. 26 is a flowchart illustrating a method 2600 of transferring power from a powerline to an in-flight UAV in accordance with embodiments of the present technology. In some embodiments, the method 2600 is an example of the in-flight charging process sequence (block 2514) discussed with reference to FIG. 25. At block 2602, an in-flight WPT unit can engage the powerline (e.g., by clamping field guiding portions around the powerline, by rotating a field guiding portion around the powerline, by being positioned proximate to or onto the powerline). At block 2604, a flight computer can confirm a lock-in position on the powerline and correct the orientation of the UAV. At block 2606, the flight computer can maintain the throttle such that the UAV enters a hover mode in which power consumption is minimized while keeping the UAV airborne. At block 2608, charging via the WPT unit can begin and WPT unit electronics can measure the rate and/or total amount of power flow to a battery onboard the UAV. At block 2610, the flight computer can coordinate with the WPT unit electronics to adjust the UAV's distance to the powerline and/or any airgaps between field guiding portions of the WPT unit in order to optimize the harvested power. At block 2612, the WPT unit can confirm that the charging is complete in coordination with the flight computer based on, for example, the battery capacity and the measured total amount of harvested power. At block 2614, the WPT unit can send a signal to the flight computer indicating charging completion. At block 2616, the flight computer can command the WPT unit to disengage and/or move away from the powerline by, for example, increasing the throttle. At block 2618, the flight computer can command the WPT unit to switch to a more aerodynamic configuration, such as by closing a lower mechanical component, depending on the WPT unit design. At block 2620, the flight computer can command the UAV to enter a flight and mission mode to resume flight and continue operation.

L.5. Locked Charging Process

FIG. 27 is a flowchart illustrating a method 2700 of transferring power from a powerline to a locked UAV in accordance with embodiments of the present technology. In some embodiments, the method 2700 is an example of the locked charging process sequence (block 2516) discussed with reference to FIG. 25. At block 2702, a locked WPT component (e.g., a field guiding portion) can open up and close around a powerline, or otherwise engage the powerline. At block 2704, a flight computer can confirm the lock-in position and correct the orientation of the UAV as needed. At block 2706, the flight computer can shut down motors included in the propulsion system of the UAV and thereby enter a standby mode. At block 2708, the charging process can begin and WPT unit electronics can measure the rate and/or total amount of power flow to a battery onboard the UAV. At block 2710, the flight computer can coordinate with the WPT unit to confirm that the charging is complete based on, for example, the battery capacity and the measured total amount of harvested power. At block 2712, the WPT unit can send a signal to the flight computer indicating charging completion. At block 2714, the flight computer can set the throttle to hover mode. At block 2716, the flight computer can command the WPT unit to disengage from the powerline by, for example, opening up a field guiding portion. At block 2718, the flight computer can command the WPT unit to switch to a more aerodynamic configuration, such as by closing a lower mechanical component, depending on the WPT unit design. At block 2720, the flight computer can command the UAV to enter a flight and mission mode to resume flight and continue operation.

### M. ADVANTAGES OF EMBODIMENTS OF THE PRESENT TECHNOLOGY

At least some embodiments of the present technology are expected to have one or more of the following advantages:
1. Circuit level technologies that improve the reception of energy and reduce the sensitivity of the wireless transfer system to environmental variants.
2. A receiving system that can make use of both inductive and capacitive based wireless power transferring with shared hardware). In addition, the receiving system can regulate induced power by dynamically adjusting the coupling factor. To control the flux when the current is in peak, a variable air gap approach can be used to reduce the coupling if the received power is more than what is required. Such an approach can be implemented by increasing the air gap in, for example, a clamp shaped receiver.
3. Increasing the flux density in the receiver coil or plate using field guiding material.

Embodiments of the present technology can include a wireless charging system (hybrid of IPT and CPT based systems) capable of harvesting at least 150 W of power from a 50 Hz cable carrying about 100 A of current with an air gap of about 10 mm, or 5-15 W within an air gap of about 15 cm.

Additionally:
1. A very low frequency power signal can generate very low coupling between the receiver coil on the UAV and the cable. To increase the coupling and ensure that the overall weight of the system is within acceptable limits, the present technology can increase the coupling coefficient between the power line cable and the receiver coil and guide the fields that are circulating towards the receiver coil.
   a. For capacitive coupling, the present technology can improve the coupling factor by one or more of the following:
      i. Increasing the area of the capacitive plate. This method directly increases the coupling capacitance and therefore increases the harvested energy.
      ii. Reducing the distance between plate and the cable.
      iii. Adding a second plate for double plate capacitive coupling between each phase of the transmission line.
      iv. Filling some of the air gap with a highly dielectric material like barium titanate. This can increase the capacitance and guide the electric field to the receptor plate(s).
   b. For inductive coupling, the present technology can improve the coupling factor by one or more of the following:
      i. Increasing the number of coils located normal to the magnetic fields of the powerlines.
      ii. Increasing the area of the coils.
      iii. Increasing the number of turns of each coil.
      iv. Guiding the magnetic field using ferromagnetic materials positioned proximate to the receptor coils.
      v. Using the clamp shape coils wound around a ferrite material.
   c. The present technology can incorporate both magnetic coupling (for inductive charging) and electric coupling (for capacitive charging) in the same receptor design.
2. The nature of the transmission lines is to carry enough current to meet the demand required by the user load. Since this load is variable, the current passing through transmission lines can vary by 10 times (e.g., 100-500 A). This change can significantly impact the intensity of the magnetic field generated by these cables and therefore the amount of the induced current harvested through magnetic coupling. The UAVs of the present technology can adapt themselves to the current value of the load in the network and, based on the adaptation, adjust the coupling between two coils to receive constant energy for battery and flying needs.

Moreover, wireless power transfer using embodiments of the present technology can be accomplished even with the low frequency common to power transmission lines (50-60 Hz) and the power requirements of UAVs for utility inspection applications. In addition, the distance between the receiver system (e.g., the WPT unit) and the transmission lines (e.g., powerlines) can be optimized to reduce the risk of potential damage to transmission lines. Multiple methods are disclosed for this purpose including, for example: (1) capacitive power transfer using capacitively coupled capacitors (CPT) and (2) inductive power transfer using inductively coupled coils (IPT). While usually the latter provides higher wireless power transfer efficiency at lower frequencies, due to the extremely high voltage nature of the transmission lines (230,000V-765,000V), the CPT approach can be incorporated as a standalone or hybrid system.

M.1 Wireless Charging Based on Capacitive Coupling

FIG. 28A is a schematic perspective view of a capacitor plate 2852, similar to the capacitive plate 1652 of FIG. 16A, disposed proximate to powerlines 102 in accordance with embodiments of the present technology. In the illustrated embodiment, four powerlines 102 are shown with a cable spacer 2804.

In some embodiments, the capacitor plate 2852 can comprise a curved surface with a length (e.g., 20 cm) and configured for placement at a distance (e.g., 15 cm) from one of the powerlines 102. Similar to the capacitor plate 1652 described above, the capacitor plate 2852 can capacitively couple to the nearest powerline and react to the AC current carried therein. In some example instances, the coupling capacitance value can be approximately 10 pF. This value increases linearly with the inverse of the distance between the capacitor plate 2852 and the one of the powerlines 102. In some embodiments, to ensure that the CPT system is in resonance weight C_{RG}=15 μF, the value of the inductor can be near 0.7 H, which can weigh less 0.5 lbs.

With a series resonator at the receiver side in some embodiments, the system can achieve about 20 W of power with a reasonable size inductor (0.7 H). Such a configuration allows for the use of a relatively small or miniaturized UAV flying over cables while harvesting enough energy (e.g., less than 10 W, or less than 30 W) to keep continuously flying and monitoring.

M.2 Wireless Power Transfer Based on Inductive Coupling

FIG. 28B is a perspective view of a WPT unit 2830 with inductive and capacitive charging components disposed proximate to the powerlines 102 in accordance with embodiments of the present technology. FIG. 28C is an enlarged perspective view of the WPT unit 2830. In some embodiments, it is possible to implement the CPT receiver in a clamp shape device that can also implements IPT technology, as shown in FIGS. 28B-C. In the illustrated embodiment, the UAV includes a clamp-based approach incorporating a hybrid IPT and CPT WPT unit 2830. Eight induction coils 2832 are shown that are configured in parallel over or wound around a field guiding portion 2834 and the capacitor plate 2852. In some embodiments, the capacitor plate 2852 can be used as both a part in the CPT system and the resonator capacitance in the IPT system.

Some embodiments of the present technology can include an additional coupling apparatus that can increase the coupling coefficient between the induction coil 2832 and the powerlines 102 at any sizes and can address the large variation of current in the powerlines 102 (e.g., at different times of the day or year). In some embodiments, the harvested power with the illustrated WPT unit 2830 can be on order of 1000 W. In some aspects of the present technology, it is expected that a UAV system can harvest up to 50 W of power from a hovering coil receiver with an approximate weight of 0.4 lbs and up to 1200 W from a clamp shape coil with a weight of about 7.7 lbs. Since the distance between the plate of the coupling capacitance is much shorter, harvested power can be much higher. This can suffice charging larger aircrafts for more complex missions.

Additionally, a higher watt-per-weight ratio is often desirable. In some embodiments, the weight of the battery in the present technology can be reduced (e.g., by about 50% compared to conventional UAVs) because the UAV may not need as much stored battery power since it is configured to charge while operating, as described in detail herein. Accordingly, a higher watt-per-weight factor and a pass and fail line can be drawn based on W/lb trends in existing UAVs in the market.

### N. EXAMPLE CLAUSES

The following examples are illustrative of several embodiments of the present technology:

1. An unmanned aerial vehicle system, comprising:
an unmanned aerial vehicle (UAV);
a wireless power transfer (WPT) unit carried by the UAV, wherein the WPT unit is configured to transfer power from a powerline to the UAV, the WPT unit comprising:
   a first field guiding portion configured to wirelessly couple to the powerline;
   a second field guiding portion operatively coupled to the first field guiding portion; and
   an induction coil operatively coupled to the UAV and at least partially wound around at least one of the first field guiding portion or the second field guiding portion,
   wherein the first and second field guiding portions are configured to guide a magnetic field generated by current passing through the powerline toward the induction coil.

2. The unmanned aerial vehicle system of example 1, wherein the WPT unit further comprises an actuator operatively coupled to at least one of the first field guiding portion or the second field guiding portion to control an airgap between the first and second field guiding portions.

3. The unmanned aerial vehicle system of examples 1-2, wherein:
a shape of the first field guiding portion comprises a portion of a first ring,
the first field guiding portion has a cavity;
a shape of the second field guiding portion comprises a portion of a second ring,
the second field guiding portion is positioned to move at least partially into and out of the cavity, and
the WPT unit further comprises an actuator operatively coupled to the second field guiding portion to move the second field guiding portion at least partially into and out of the cavity.

4. The unmanned aerial vehicle system of examples 1-2, wherein:
a shape of the first field guiding portion comprises a first partial-ring,
a shape of the second field guiding portion comprises a second partial-ring, and
the WPT unit further comprises an actuator operatively coupled to at least one of the first field guiding portion or the second field guiding portion to move at least one of the first field guiding portion toward or away from the second field guiding portion along a non-straight pathway.

5. The unmanned aerial vehicle system of examples 1-2, wherein:
a shape of the first field guiding portion comprises a first partial-ring,
a shape of the second field guiding portion comprises a second partial-ring, and
the WPT unit further comprises an actuator operatively coupled to at least one of the first field guiding portion or the second field guiding portion to move at least one of the first field guiding portion toward or away from the second field guiding portion along a straight pathway.

6. The unmanned aerial vehicle system of examples 1-2, wherein the first field guiding portion comprises a first elongate member, and wherein the second field guiding portion comprises a second elongate member extending parallel to and spaced apart from the first elongate member.

7. The unmanned aerial vehicle system of examples 1-6, further comprising a plurality of bearing members disposed around the first and second field guiding portions, wherein the bearing members are positioned to facilitate movement of the WPT unit along the powerline.

8. The unmanned aerial vehicle system of examples 1-7, wherein the powerline extends along a powerline axis, wherein the WPT unit is a first WPT unit, wherein the induction coil is a first induction coil, wherein the first WPT unit further comprises a first actuator operatively coupled to the first field guiding portion, and wherein the system further comprises:
a second WPT unit carried by the UAV, wherein the second WPT unit is configured to transfer power from the powerline to the UAV, the second WPT unit comprising:
   a second induction coil operatively coupled to the UAV;
   a third field guiding portion disposed proximate to the second induction coil;
   a fourth field guiding portion operatively coupled to the third field guiding portion,
   wherein the third and fourth field guiding portions are configured to guide the magnetic field generated by the current passing through the powerline toward the second induction coil; and
   a second actuator operatively coupled to the third field guiding portion,
wherein the first and second actuators are positioned to rotate the first and third field guide portions about a first axis and a second axis, respectively, wherein the first and second axes are generally perpendicular to the powerline axis.

9. The unmanned aerial vehicle system of examples 1-8, further comprising at least one support member carried by the UAV, wherein the at least one support member is configured to releasably attach to the powerline and stabilize the UAV during power transfer by the WPT unit.

10. The unmanned aerial vehicle system of examples 1-9, further comprising a flight controller operatively carried by the UAV and configured to control a distance between the induction coil and the powerline.

11. The unmanned aerial vehicle system of examples 1-10, further comprising a WPT controller operatively coupled to the WPT unit and configured to control a distance between the first field guiding portion and the second field guiding portion.

12. The unmanned aerial vehicle system of examples 1-11, wherein the WPT unit further comprises:
a capacitor plate having a first side and a second side opposite the first side, wherein the first side is operatively coupled to the UAV; and
a dielectric material adjacent to the second side of the capacitor plate.

13. A wireless power transfer (WPT) unit to be carried by an unmanned aerial vehicle, comprising:
a first field guiding portion configured to wirelessly couple to an electrical cable;
a second field guiding portion operatively coupled to the first field guiding portion;
an induction coil at least partially wound around at least one of the first field guiding portion or the second field guiding portion, wherein the induction coil is configured to wirelessly couple to the electrical cable through at least one of the first field guiding portion or the second field guiding portion; and
a support carried by at least one of the first field guiding portion, the second field guiding portion, or the induction coil,
wherein the first and second field guiding portions are configured to guide a magnetic field toward the induction coil, and
wherein the support is positioned to connect to, and be carried by, an unmanned aerial vehicle.

14. The WPT unit of example 13, wherein:
the first field guiding portion has a cavity;
the second field guiding portion is positioned to move at least partially into and out of the cavity, and
the WPT unit further comprises an actuator operatively coupled to the second field guiding portion to move the second field guiding portion at least partially into and out of the cavity.

15. The WPT unit of example 13, further comprising an actuator operatively coupled to at least one of the first field guiding portion or the second field guiding portion to move at least one of the first field guiding portion toward or away from the second field guiding portion along a straight pathway.

16. The WPT unit of example 13, further comprising an actuator operatively coupled to at least one of the first field guiding portion or the second field guiding portion to move at least one of the first field guiding portion toward or away from the second field guiding portion along a non-straight pathway.

17. The WPT unit of example 13, wherein the first field guiding portion comprises a first elongate member, and wherein the second field guiding portion comprises a second elongate member extending parallel to and spaced apart from the first elongate member.

18. The WPT unit of examples 13-17, further comprising a plurality of bearing members disposed around the first and second field guiding portions, wherein the bearing members are positioned to facilitate movement of the WPT unit along a powerline.

19. The WPT unit of examples 13-18, further comprising:
a capacitive plate carried by the support, the first field guiding portion, or both, the capacitive plate configured to provide a capacitor terminal for capacitively coupling to the electrical cable across a separation space between the electrical cable and the capacitive plate, wherein the capacitive plate is electrically coupled to the induction coil for leveraging both capacitive and inductive electro-magnetic coupling in generating power from the wirelessly coupled electrical cable.

20. A method for transferring power to a battery carried by an unmanned aerial vehicle (UAV), comprising:
receiving an indication of an amount of power carried by the battery;
positioning the UAV proximate to a powerline;
engaging a wireless power transfer (WPT) unit carried by the UAV with the powerline, wherein the WPT unit comprises:
   a first field guiding portion configured to wirelessly couple to the powerline and receive magnetic forces caused by an alternating current (AC) traversing through the powerline;
   a second field guiding portion operatively coupled to the first field guiding portion; and
   an induction coil operatively coupled to the UAV, at least partially wound around a length of at least one of the first field guiding portion and the second field guiding portion, and configured to generate power in reaction to the received magnetic forces, wherein the power is used to operate the UAV and/or charge the battery;
disengaging the WPT unit from the powerline; and
positioning the UAV away from the powerline.

21. The method of example 20, wherein the WPT unit further comprises an actuator operatively coupled to at least one of the first field guiding portion or the second field guiding portion, and wherein engaging the WPT unit comprises:
engaging the first field guiding portion with the powerline; and
controlling the actuator to move the second field guiding portion toward the first field guiding portion such that the second field guiding portion engages with the powerline.

22. The method of examples 20-21, wherein the powerline extends along a powerline axis, wherein the WPT unit is a first WPT unit, wherein the induction coil is a first induction coil, wherein the first WPT unit further comprises a first actuator operatively coupled to at least one of the first field guiding portion or the second field guiding portion, and wherein the method further comprises:
engaging a second WPT unit attached to the UAV with the powerline, wherein the second
   WPT unit comprises:
   a second induction coil operatively coupled to the UAV,
   a third field guiding portion disposed proximate to the second induction coil;
   a fourth field guiding portion operatively coupled to the third field guiding portion; and
   a second actuator operatively coupled to at least one of the third field guiding portion or the fourth field guiding portion;
controlling the first and second actuators to rotate the first and third field guide portions about a first axis and a second axis, respectively, such that the first and second WPT units contact the powerline, wherein the first and second axes are generally perpendicular to the powerline axis; and
disengaging the second WPT unit from the powerline.

23. The method of examples 20-22, further comprising:
prior to transferring the power, releasably attaching at least one support member to the powerline, wherein the at least one support member is carried by the UAV;
stabilizing the UAV relative to the powerline via the at least one support member, while transferring the power via the WPT unit; and after transferring the power, releasing the at least one support member from the powerline.

24. The method of examples 20-22, further comprising:
prior to disengaging the WPT unit, applying a reverse current in the induction coil, wherein the reverse current includes a phase shift of 180 degrees relative to current flowing through the powerline.

25. The method of examples 20-24, further comprising:
controlling the UAV to enter a hover mode prior to transferring the power, wherein the UAV remains airborne while in the hover mode while transferring the power.

26. The method of examples 20-25, further comprising:
controlling the UAV to enter a standby mode prior to transferring the power, wherein a propulsion system of the UAV is turned off while in the standby mode while transferring the power.

27. The method of examples 20-26, further comprising:
measuring a rate of power transfer from the powerline to the UAV; and calculating current in the powerline in real-time based on the measured rate of power transfer.

28. The method of examples 20-27, further comprising:
controlling an airgap between the first and second field guiding portions, thereby controlling a rate of power transfer from the powerline to the UAV.

29. The method of examples 20-28, further comprising:
determining one or more harmonic components within the generated power;
measuring an amount of the generated power; and
estimating a current carried by the powerline according to the one or more harmonic components and the amount of the generated power.

30. The method of examples 20-29, wherein the first field guiding portion includes a non-linear ferrous material that operates in a linear or non-linear region:
determining one or more harmonic components within the generated power;
operating the UAV to adjust (1) an airgap between the WPT unit and the powerline, (2) an orientation of the WPT unit relative to the powerline, or both for maintaining the wireless coupling between the WPT unit and the powerline in the linear operational region of the non-linear ferrous material.

### O. CONCLUSION

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any materials incorporated herein by reference conflict with the present disclosure, the present disclosure controls. Where the context permits, singular or plural terms can also include the plural or singular term, respectively. As used herein, the phrase “and/or” as in “A and/or B” refers to A alone, B alone, and both A and B. Where the context permits, singular or plural terms can also include the plural or singular term, respectively. Additionally, the terms “comprising,” “including,” “having” and “with” are used throughout to mean including at least the recited feature(s) such that any greater number of the same feature and/or additional types of other features are not precluded.

Furthermore, as used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. Moreover, the terms “connect” and “couple” are used interchangeably herein and refer to both direct and indirect connections or couplings. For example, where the context permits, element A “connected” or “coupled” to element B can refer (i) to A directly “connected” or directly “coupled” to B, and/or (ii) to A indirectly “connected” or indirectly “coupled” to B.

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while blocks are presented in a given order, alternative embodiments can perform blocks in a different order. As another example, various components of the technology can be further divided into subcomponents, and/or various components and/or functions of the technology can be combined and/or integrated. Furthermore, although advantages associated with certain embodiments of the technology have been described in the context of those embodiments, other embodiments can also exhibit such advantages, and not all embodiments need necessarily exhibit such advantages to fall within the scope of the technology.

The headings provided herein are for convenience only and do not necessarily affect the scope of the embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to unnecessarily limit the embodiments described. Rather, the embodiments are intended to cover all modifications, combinations, equivalents, and alternatives falling within the scope of this disclosure.

It should also be noted that other embodiments in addition to those disclosed herein are within the scope of the present technology. For example, embodiments of the present technology can have different configurations, components, and/or procedures in addition to those shown or described herein. Moreover, a person of ordinary skill in the art will understand that these and other embodiments can be without several of the configurations, components, and/or procedures shown or described herein without deviating from the present technology. Accordingly, the disclosure and associated technology can encompass other embodiments not expressly shown or described herein.

Reference in this specification to “one embodiment” or “an embodiment” means that a particular feature, structure, or characteristic described in connection with the embodiment is included in at least one embodiment of the disclosure. The appearances of the phrase “in one embodiment” (or the like) in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

I/We claim:

1. An unmanned aerial vehicle system, comprising:
an unmanned aerial vehicle (UAV);
a wireless power transfer (WPT) unit carried by the UAV, wherein the WPT unit is configured to transfer power from a powerline to the UAV, the WPT unit comprising:
a first field guiding portion configured to wirelessly couple to the powerline;
a second field guiding portion operatively coupled to the first field guiding portion; and
an induction coil operatively coupled to the UAV and at least partially wound around at least one of the first field guiding portion or the second field guiding portion,
wherein the first and second field guiding portions are configured to guide a magnetic field generated by current passing through the powerline toward the induction coil.

2. The unmanned aerial vehicle system of claim 1, wherein the WPT unit further comprises an actuator operatively coupled to at least one of the first field guiding portion or the second field guiding portion to control an airgap between the first and second field guiding portions.

3. The unmanned aerial vehicle system of claim 1, wherein:
a shape of the first field guiding portion comprises a portion of a first ring,
the first field guiding portion has a cavity;
a shape of the second field guiding portion comprises a portion of a second ring,
the second field guiding portion is positioned to move at least partially into and out of the cavity, and
the WPT unit further comprises an actuator operatively coupled to the second field guiding portion to move the second field guiding portion at least partially into and out of the cavity.

4. The unmanned aerial vehicle system of claim 1, wherein:
a shape of the first field guiding portion comprises a first partial-ring,
a shape of the second field guiding portion comprises a second partial-ring, and
the WPT unit further comprises a non-straight rail and an actuator operatively coupled to at least one of the first field guiding portion or the second field guiding portion to move at least one of the first field guiding portion toward or away from the second field guiding portion along the non-straight rail.

5. The unmanned aerial vehicle system of claim 1, wherein:
a shape of the first field guiding portion comprises a first partial-ring,
a shape of the second field guiding portion comprises a second partial-ring, and
the WPT unit further comprises a straight rail and an actuator operatively coupled to at least one of the first field guiding portion or the second field guiding portion to move at least one of the first field guiding portion toward or away from the second field guiding portion along the straight rail.

6. The unmanned aerial vehicle system of claim 1, wherein the first field guiding portion comprises a first elongate member, and wherein the second field guiding portion comprises a second elongate member extending parallel to and spaced apart from the first elongate member.

7. The unmanned aerial vehicle system of claim 1, wherein the powerline extends along a powerline axis, wherein the WPT unit is a first WPT unit, wherein the induction coil is a first induction coil, wherein the first WPT unit further comprises a first actuator operatively coupled to the first field guiding portion, and wherein the system further comprises:
a second WPT unit carried by the UAV, wherein the second WPT unit is configured to transfer power from the powerline to the UAV, the second WPT unit comprising:
a second induction coil operatively coupled to the UAV;
a third field guiding portion disposed proximate to the second induction coil;
a fourth field guiding portion operatively coupled to the third field guiding portion,
wherein the third and fourth field guiding portions are configured to guide the magnetic field generated by the current passing through the powerline toward the second induction coil; and
a second actuator operatively coupled to the third field guiding portion,
wherein the first and second actuators are positioned to rotate the first and third field guide portions about a first axis and a second axis, respectively, wherein the first and second axes are generally perpendicular to the powerline axis.

8. A wireless power transfer (WPT) unit to be carried by an unmanned aerial vehicle, comprising:
a first field guiding portion configured to wirelessly couple to an electrical cable;
a second field guiding portion operatively coupled to the first field guiding portion;
an induction coil at least partially wound around at least one of the first field guiding portion or the second field guiding portion, wherein the induction coil is configured to wirelessly couple to the electrical cable through at least one of the first field guiding portion or the second field guiding portion; and
a support carried by at least one of the first field guiding portion, the second field guiding portion, or the induction coil,
wherein the first and second field guiding portions are configured to guide a magnetic field toward the induction coil, and
wherein the support is positioned to connect to, and be carried by, an unmanned aerial vehicle.

9. The WPT unit of claim 8, further comprising a non-straight rail and an actuator operatively coupled to at least one of the first field guiding portion or the second field guiding portion to move at least one of the first field guiding portion toward or away from the second field guiding portion along the non-straight rail.

10. The WPT unit of claim 8, wherein the first field guiding portion comprises a first elongate member, and wherein the second field guiding portion comprises a second elongate member extending parallel to and spaced apart from the first elongate member.

11. The WPT unit of claim 8, further comprising:
a capacitive plate carried by the support, the first field guiding portion, or both, the capacitive plate configured to provide a capacitor terminal for capacitively coupling to the electrical cable across a separation space between the electrical cable and the capacitive plate, wherein the capacitive plate is electrically coupled to the induction coil for leveraging both capacitive and inductive electro-magnetic coupling in generating power from the wirelessly coupled electrical cable.

12. A method for transferring power to a battery carried by an unmanned aerial vehicle (UAV), comprising:
receiving an indication of an amount of power carried by the battery;
positioning the UAV proximate to a powerline;
engaging a wireless power transfer (WPT) unit carried by the UAV with the powerline, wherein the WPT unit comprises:
a first field guiding portion configured to wirelessly couple to the powerline and receive magnetic forces caused by an alternating current (AC) traversing through the powerline;
a second field guiding portion operatively coupled to the first field guiding portion; and
an induction coil operatively coupled to the UAV, at least partially wound around a length of at least one of the first field guiding portion and the second field guiding portion, and configured to generate power in reaction to the received magnetic forces, wherein the power is used to operate the UAV and/or charge the battery;
disengaging the WPT unit from the powerline; and
positioning the UAV away from the powerline.

13. The method of claim 12, wherein the powerline extends along a powerline axis, wherein the WPT unit is a first WPT unit, wherein the induction coil is a first induction coil, wherein the first WPT unit further comprises a first actuator operatively coupled to at least one of the first field guiding portion or the second field guiding portion, and wherein the method further comprises:
engaging a second WPT unit attached to the UAV with the powerline, wherein the second WPT unit comprises:
a second induction coil operatively coupled to the UAV,
a third field guiding portion disposed proximate to the second induction coil;
a fourth field guiding portion operatively coupled to the third field guiding portion; and
a second actuator operatively coupled to at least one of the third field guiding portion or the fourth field guiding portion;
controlling the first and second actuators to rotate the first and third field guide portions about a first axis and a second axis, respectively, such that the first and second WPT units contact the powerline, wherein the first and second axes are generally perpendicular to the powerline axis; and
disengaging the second WPT unit from the powerline.

14. The method of claim 12, further comprising:
prior to disengaging the WPT unit, applying a reverse current in the induction coil, wherein the reverse current includes a phase shift of 180 degrees relative to current flowing through the powerline.

15. The method of claim 12, further comprising:
controlling the UAV to enter a hover mode prior to transferring the power, wherein the UAV remains airborne while in the hover mode while transferring the power.

16. The method of claim 12, further comprising:
controlling the UAV to enter a standby mode prior to transferring the power, wherein a propulsion system of the UAV is turned off while in the standby mode while transferring the power.

17. The method of claim 12, further comprising:
measuring a rate of power transfer from the powerline to the UAV; and
calculating current in the powerline in real-time based on the measured rate of power transfer.

18. The method of claim 12, further comprising:
controlling an airgap between the first and second field guiding portions, thereby controlling a rate of power transfer from the powerline to the UAV.

19. The method of claim 12, further comprising:
determining one or more harmonic components within the generated power;
measuring an amount of the generated power; and
estimating a current carried by the powerline according to the one or more harmonic components and the amount of the generated power.

20. The method of claim 12, wherein the first field guiding portion includes a non-linear ferrous material that operates in a linear or non-linear region:
determining one or more harmonic components within the generated power;
operating the UAV to adjust (1) an airgap between the WPT unit and the powerline, (2) an orientation of the WPT unit relative to the powerline, or both for maintaining the wireless coupling between the WPT unit and the powerline in the linear operational region of the non-linear ferrous material.
